(19) United States
(12) Patent Application Publication
(10) Pub. No.: US 2025/0360466 A1
(43) Pub. Date: Nov. 27, 2025

(54) GRAPHENE OXIDE MEMBRANES COMPRISING SULFONATED SUPPORT

(71) Applicant: Via Separations, Inc., Watertown, MA (US)

(72) Inventors: Cole Joseph HARRIS, Boston, MA (US); Stephen FRAYNE, Wayland, MA (US); Brent D. KELLER, Somerville, MA (US)

(21) Appl. No.: 19/294,014

(22) Filed: Aug. 7, 2025

Related U.S. Application Data
(63) Continuation of application No. PCT/US2024/015998, filed on Feb. 15, 2024.
(60) Provisional application No. 63/445,949, filed on Feb. 15, 2023.

(51) Int. Cl. B01D 71/02; B01D 69/10; B01D 69/12

(52) U.S. Cl. CPC B01D 71/0211; B01D 69/1071; B01D 69/1216

(57) ABSTRACT

Filtration apparatus including Graphene Oxide (GO) are described herein. The GO membranes include a plurality of graphene oxide sheets, each of the graphene oxide sheets covalently bound to a chemical spacer. The filtration apparatus can include a GO membrane and a sulfonated polyethersulfone (S-PES). The filtration apparatus can exhibit improved performance with respect to prior art membranes (e.g., high flux and rejection rate) in applications such as pulp and paper processing, which facilitates achieving permeate quality targets. The filtration apparatus described herein can also offer a more stable replacement for reverse osmosis membranes which are known to degrade under strongly alkaline conditions and high temperatures.

### CROSS-REFERENCE TO RELATED APPLICATIONS

This application is a continuation of International Patent Application No. PCT/US2024/015998, entitled “Graphene Oxide Membranes Comprising Sulfonated Support,” filed Feb. 15, 2024, which claims priority to and the benefit of U.S. Provisional Patent Application 63/445,949, entitled “Graphene Oxide Membranes Comprising Sulfonated Support,” filed Feb. 15, 2023, the disclosure of each of which is incorporated by reference herein in its entirety

### TECHNICAL FIELD

The present disclosure relates generally to graphene oxide membranes and their use in separation processes.

### BACKGROUND

Membranes can be used to separate a mixture by passing some components (filtrate or permeate) and retaining others preferentially with a balance of the mixture (rejects) according to any of a variety of properties of the membrane and/or of the components of the material being filtered. For example, membranes can be configured to separate rejects from a filtrate based on size exclusion (i.e., a physical barrier such as pores that are smaller than the excluded particles). Other examples include membranes that are configured to separate rejects from a filtrate based on chemical, electrochemical, and/or physical binding with one or more components of the material being filtered.

Polymer membranes are a common type of membrane. They have been used commercially in a wide range of applications including water softening, desalination, and for the concentration, removal, and purification of different salts, small molecules, and macromolecules. However, in certain environments (e.g., oxidizing conditions, high pH, high temperatures, or in some solvents), polymer membranes can become damaged or fail due to swelling, oxidation reactions, degradation, or softening of the polymer. Accordingly, there is a need in the art for new membranes that address one or more deficiencies of polymer membranes.

### SUMMARY

Embodiments described herein relate generally to graphene oxide membranes for fluid filtration. For example, the graphene oxide membranes can be used for concentration, removal, and purification of different salts. One aspect of the present disclosure relates to a filtration apparatus comprising: a sulfonated support; and a graphene oxide membrane disposed on the sulfonated support. The graphene oxide membrane comprises a plurality of graphene oxide layers, each graphene oxide layer including at least one graphene oxide sheet covalently coupled to a chemical spacer. In some embodiments, the filtration apparatus has a rejection rate of at least 60% in flowing a weak black liquor solution at a predetermined temperature ° C. and a predetermined pressure.

In some embodiments, the filtration apparatus has a flux of at least 3 gallons per square foot per day (GFD) in flowing the weak black liquor solution at a predetermined crossflow velocity

In some embodiments, the predetermined crossflow velocity is at least about 0.1 m/sec.

In some embodiments, the predetermined temperature is about 70° C.

In some embodiments, the predetermined pressure is at least about 300 psi.

In some embodiments, the sulfonated support includes a sulfonated polyethersulfone (S-PES) material.

In some embodiments, the sulfonated support includes a backing layer; a top layer comprising the S-PES material; and an interlayer disposed between the backing layer and the top layer.

In some embodiments, the sulfonated support includes a backing layer; and a blended top layer disposed on the backing layer, the blended top layer including the S-PES material.

In some embodiments, the backing layer includes at least one of polypropylene, polystyrene, polyethylene, polyethersulfone, or polysulfone.

In some embodiments the chemical spacer comprises an amide or a derivative thereof.

In some embodiments, the chemical spacer comprises —NH—C(O)—R2, wherein R2is C1-C6 alkyl or C2-C6 alkenyl, each of which can be optionally substituted.

In some embodiments, the amide is acrylamide, propionamide, isobutyramide, or pivalamide.

In some embodiments, the chemical spacer comprises an amine or a derivative thereof.

In some embodiments, the chemical spacer comprises —NH—R1, wherein R1 is an aryl, which can be optionally substituted.

In some embodiments, the amine is 4-aminophenylacetic acid or 2-(4-aminophenyl) ethanol.

In some embodiments, the predetermined pressure is at least about 50 psi and no more than 1200 psi.

In some embodiments, the temperature is about 70° C.

In some embodiments, each of the graphene oxide sheets is not covalently crosslinked to an adjacent graphene oxide sheet.

In some embodiments, each of the graphene oxide sheets is covalently crosslinked to an adjacent graphene oxide sheet.

In some embodiments, the filtration apparatus further comprises a chemical linker covalently coupled to the chemical spacer to crosslink each of the graphene oxide sheets to the adjacent graphene oxide sheet.

In some embodiments, the chemical linker includes one of the following structures:

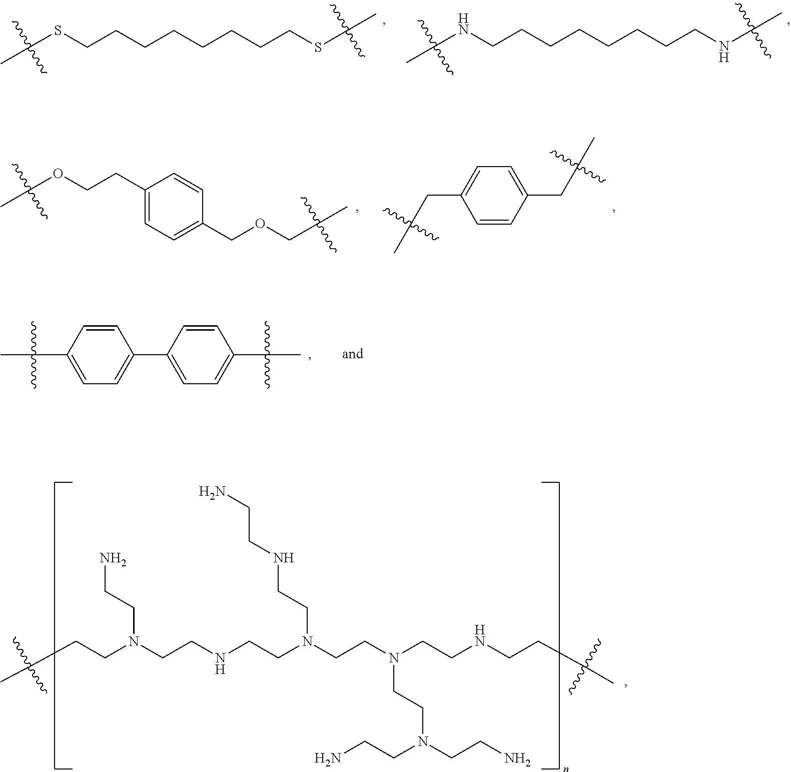

wherein:
n is 1 to 5; and [symbol]
   denotes the point of coupling to the chemical spacer.
   In some embodiments, the combination of the chemical linker and the chemical spacer has the following structure:

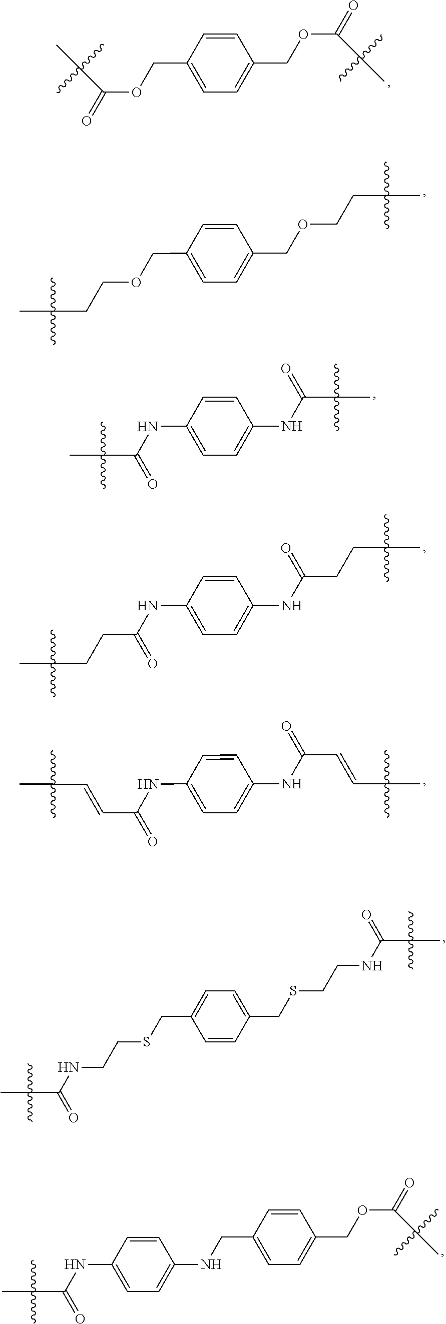

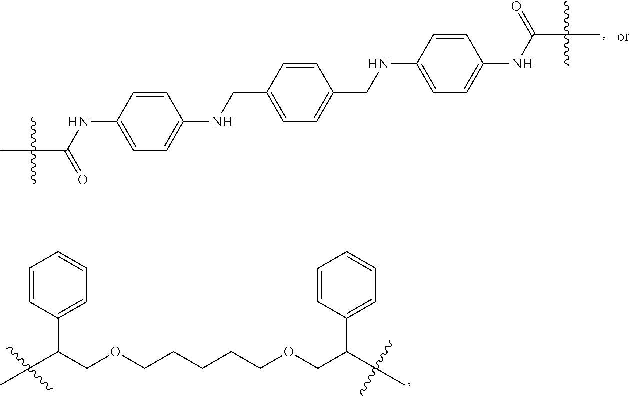 [SMILES: *C(=O)Nc1ccc(NCc2ccc(CNc3ccc(NC(*)=O)cc3)cc2)cc1 ; *C(COCCCCCOCC(*)c1ccccc1)c1ccccc1]

where [symbol] denotes the point of coupling with the graphene oxide sheet.

### BRIEF DESCRIPTION OF THE DRAWINGS

FIG. 1A is a schematic illustration of a filtration apparatus 1000 in accordance with some embodiments of the present disclosure.

FIG. 1B is a schematic illustration of a graphene oxide membrane 100B in accordance with some embodiments of the present disclosure. The graphene oxide membrane 100B comprises a plurality of graphene oxide sheets, wherein each of the graphene oxide sheets is not covalently crosslinked to the adjacent graphene oxide sheet.

FIG. 1C. is a schematic illustration of a graphene oxide membrane 100C in accordance with some embodiments of the present disclosure. The graphene oxide membrane 100C comprises a plurality of graphene oxide sheets, wherein each of the graphene oxide sheets is covalently crosslinked to the adjacent graphene oxide sheet.

FIG. 2A illustrates the chemical structure of a polyethersulfone (PES) support and a sulfonated polyethersulfone (S-PES) support according to embodiments of the present disclosure.

FIGS. 2B-2C show schematic illustrations of sulfonated supports according to embodiments of the present disclosure.

FIG. 3 shows contact angle measurements of a PES support and a S-PES sulfonated support.

FIGS. 4A-4C shows images recorded after a crockmeter adhesion test conducted on various graphene oxide membranes, including: (4A) a graphene oxide membrane comprising a propionamide chemical spacer (ps-GO membrane) disposed on a PES support (ps-GO/PES); (4B) a ps-GO membrane disposed on an S-PES sulfonated support (ps-GO/S-PES), and (4C) a graphene oxide membrane without a chemical spacer disposed on an S-PES sulfonated support (GO/S-PES), respectively.

FIG. 5 presents a graph displaying the rejection rate and flux of an S-PES sulfonated support, and a ps-GO membrane disposed on an S-PES sulfonated support (ps-GO/S-PES), measured as a function of time flowing a Weak Black Liquor (WBL) solution at 70° C. and a pressure of 300, 500, and 800 psi.

FIG. 6 presents a graph displaying the rejection rate and flux of a ps-GO membrane disposed on a (PES) support (ps-GO/PES), and a ps-GO membrane disposed on an S-PES sulfonated support (ps-GO/S-PES), measured as a function of time flowing a Weak Black Liquor (WBL) solution at 70° C. and a pressure of 300 and 500 psi.

FIG. 7 shows a thermogravimetric analyzer (TGA) curve illustrating the thermal stability of a (PES) support and a S-PES sulfonated support.

FIGS. 8A-8B show a Scanning Electron Microscope (SEM) micrograph showing the microstructure, porosity, and pore size distribution of a PES support and a S-PES sulfonated support, respectively.

FIG. 9 shows Fourier Transformed Infrared (FT-IR) spectra of a PES support and an S-PES sulfonated support recorded at room temperature.

### DETAILED DESCRIPTION

Graphite is a crystalline form of carbon with its atoms arranged in a hexagonal structure layered in a series of planes. Due to its abundance on earth, graphite is very cheap and is commonly used in pencils and lubricants. Graphene is a single, one atomic layer of carbon atoms (i.e., one of the layers of graphite) with several exceptional electrical, mechanical, optical, and electrochemical properties, earning it the nickname “the wonder material.” To name just a few, it is highly transparent, extremely light and flexible yet robust, and an excellent electrical and thermal conductor. Such extraordinary properties render graphene and related thinned graphite materials (e.g., few layer graphene) as promising candidates for a diverse set of applications. For example, graphene can be used in coatings to prevent steel and aluminum from oxidizing, and to filter salt, heavy metals, and oil from water.

Graphene oxide is an oxidized form of graphene having oxygen-containing pendant functional groups (e.g., epoxide, carboxylic acid, or hydroxyl) that exist in the form of single atom thick sheets. By oxidizing the graphene in graphite, graphene oxide sheets can be produced. For example, the graphene oxide sheets can be prepared from graphite using a modified Hummers method. Flake graphite is oxidized in a mixture of KMnO₄, H₂SO₄, and/or NaNO₃, then the resulting pasty graphene oxide is diluted and washed through cycles of filtration, centrifugation, and resuspension. The washed graphene oxide suspension is subsequently ultrasonicated to exfoliate graphene oxide particles into graphene oxide sheets and centrifuged at high speed to remove unexfoliated graphite residues. The resulting yellowish/light brown solution is the final graphene oxide sheet suspension. This color indicates that the carbon lattice structure is distorted by the added oxygenated functional groups. The produced graphene oxide sheets are hydrophilic and can stay suspended in water for months without a sign of aggregation or deposition.

Due in part for its low cost, high chemical stability, strong hydrophilicity, and compatibility with a variety of environments, graphene oxide has been explored for its use as membranes in filtration applications. For example, as compared to polymer membranes, which can be prone to oxidation, graphene oxide membranes can remain stable under oxidizing conditions. However, existing graphene oxide membranes are plagued by durability issues when exposed to high temperatures or acidic/basic conditions. For example, some existing graphene oxide membranes can achieve high rejection rates when used in reverse osmosis applications at room temperature. However, after exposure to high temperatures (e.g., greater than about 50° C.) and/or highly alkaline pH environments (e.g., pH=11) for a period of time, the performance of these graphene oxide membranes diminishes.

The performance of existing graphene oxide membranes can also be negatively impacted by a number of deficiencies associated with poor adhesion between the graphene oxide membrane and other components of a filtration apparatus. Graphene oxide membranes are typically disposed on a support layer to provide mechanical integrity, strength, and stiffness to a filtration apparatus. During their fabrication, a solution and/or dispersion containing graphene oxide is generally casted onto the support layer, and then allowed to solidify to produce the graphene oxide membrane. When the graphene oxide solution and/or dispersion is first casted onto the support layer, the solution and/or dispersion penetrates beyond the surface of the support layer and subsequently solidifies around and/or near the surface of the support layer, providing mechanical interlocking between the graphene oxide membrane and the support layer. In some instances, low and/or insufficient chemical affinity between the graphene oxide solution and/or dispersion and the support layer can result in poor mechanical interlocking, which in turn leads to membrane defects and delamination issues. Delamination of the graphene oxide membrane and the support layer during use of the graphene oxide membrane results in non-uniformity of the graphene oxide membrane and compromised filtration performance.

Fabrication of graphene oxide membranes often times involve coating, rolling and/or physical handling of the membrane and the support layer. When a graphene oxide membrane has poor adhesion with the support layer, even minimal contact with the graphene oxide membrane can remove the graphene oxide coating. Furthermore, environmental conditions such as changing humidity and/or temperature during storage and/or transport can severely affect a graphene oxide coating that has poor adhesion to the support substrate layer. The adhesion between the graphene oxide membrane and the support layer can also play an important role when a filtration apparatus is introduced into a process flow. Poor adhesion between the graphene oxide membrane and the support layer can cause graphene oxide coating damage or delamination. Conversely, with good adhesion between the graphene oxide membrane and the support layer can lead to filtration apparatus with improved tolerance to physical and chemical stressors.

The present disclosure provides filtration devices and graphene oxide membranes that address the limitations of current graphene oxide membranes and exhibit one or more superior properties over existing graphene oxide membranes. At least by incorporating a sulfonated support which provides an improved chemical affinity and adhesion to graphene oxide membranes, the present disclosure provides filtration devices and graphene oxide membranes displaying high rejection rates and stability under high temperatures and/or highly alkaline pH environment. In particular, the use of sulfonated supports and graphene oxide membranes with tuned chemistries covalently coupled to each graphene oxide sheet, can result in high chemical affinity (e.g., hydrophilicity) between the graphene oxide membrane and the sulfonated support layer, which translates in significant improvements in adhesion of membrane components, performance and stability under high temperatures and/or highly alkaline pH environment.

### Filtration Apparatus

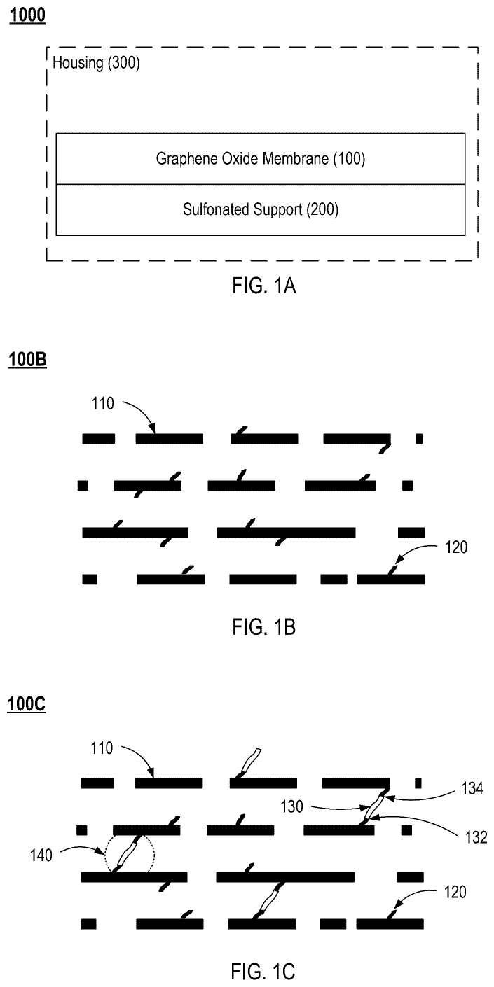

FIG. 1A shows a schematic illustration of a filtration apparatus 1000 according to the present disclosure. The filtration apparatus 1000 includes a graphene oxide membrane 100, a sulfonated support 200, and optionally a housing 300. The graphene oxide membrane 100 can be disposed on the sulfonated support 200, and the optional housing 300 can enclose the sulfonated support 200 and the graphene oxide membrane 100.

In some embodiments, the graphene oxide membrane 100 and the sulfonated support 200 can have a combined thickness of about 50 μm to about 1300 μm, (e.g., about 50 μm, about 60 μm, about 80 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1100 μm, about 1200 μm, or about 1300 μm, including any values and subranges in between.) For example, in some embodiments the graphene oxide membrane 100 and the sulfonated support 200 can have a combined thickness of about 100 μm to about 750 μm, about 200 μm to about 1000 μm, or about 200 μm to about 1200 μm, inclusive of all values and ranges therebetween.

In some embodiments, the filtration apparatus 1000 can comprise a plurality of flat polymer sheets combined to form a spiral filtration module. For example, in some embodiments, a spiral filtration module can comprise a plurality of flat polymer sheets stacked atop one another, and the plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel.

In some embodiments, the filtration apparatus 1000 includes about 0.1 mg to 6 mg of the graphene oxide membrane 100 per 5000 mm². In some embodiments, the filtration apparatus 1000 includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the graphene oxide membrane 100 per 5000 mm². For example, the filtration apparatus 1000 can include about 1 mg, about 1.5 mg, about 2 mg, about 2.5 mg, or about 3 mg of the graphene oxide membrane 100 per 5000 mm².

FIG. 1B shows a schematic diagram of a graphene oxide membrane 100B, according to some embodiments. The graphene oxide membrane 100B includes a plurality of graphene oxide sheets 110 and a plurality of chemical spacers 120. Each of the graphene oxide sheets 110 is not covalently crosslinked to the adjacent graphene oxide sheet 110.

FIG. 1C shows a schematic diagram of a graphene oxide membrane 100C, according to some embodiments. The graphene oxide membrane 100C includes a plurality graphene oxide sheets 110, a plurality of chemical spacers 120, and a plurality of chemical linkers 130. As shown in FIG. 1C, in some embodiments, the graphene oxide sheets 110 can optionally be coupled to an adjacent graphene oxide sheet 110 via at least one chemical linker 130, wherein the chemical linker 130 is covalently coupled to the chemical spacer 120 on each graphene oxide sheet 110.

The graphene oxide sheets 110 can include flakes. The flakes can have an aspect ratio (on the plane of the graphene oxide sheets 110). In some embodiments, the aspect ratio can be less than about 250,000:1, less than about 100,000:1, less than about 50,000:1, less than about 25,000:1, less than about 10,000:1, less than about 5,000:1, less than about 1,000:1. In some embodiment, the flakes can have an aspect ratio of at least about 100:1, at least about 200:1, at least about 300:1, at least about 400:1, or at least about 500:1, inclusive of all values and ranges therebetween.

In some embodiments, the size of the space between graphene oxide sheets 110 is the d-spacing, which can be measured by X-ray diffraction such as grazing incidence X-ray diffraction (GIXRD). In some embodiments, the d-spacing for dried graphene oxide sheets 110 can be less than about 20 Å, less than about 15 Å, or less than about 10 Å, inclusive of all values and ranges therebetween. In some embodiments, the d-spacing for dried graphene oxide sheets 110 can be in the range of about 5 Å to about 20 Å, about 5 Å to about 15 Å, about 8 Å to about 20 Å, about 8 Å to about 15 Å, inclusive of all values and ranges therebetween. In some embodiments, the d-spacing for dried graphene oxide sheets 110 can be about 17 Å, about 16 Å, about 15 Å, about 14 Å, about 13 Å, about 12 Å, about 11 Å, about 10 Å, about 9 Å, about 8 Å, or about 7 Å. The length of the chemical spacer 120 can be an important factor in controlling the d-spacing. The length of the chemical linker 130 can also be an important factor in controlling the d-spacing.

In some embodiments, the graphene oxide membrane 100 can include at least about 100 layers, at least about 125 layers, at least about 150 layers, at least about 200 layers, at least about 225 layers, at least about 250 layers of graphene sheets, inclusive of all values and ranges therebetween. In some embodiments, the graphene oxide membrane 100 can include no more than about 600 layers, no more than about 550 layers, no more than about 500 layers, no more than about 450 layers, no more than about 400 layers, no more than about 350 layers, or no more than about 300 layers of graphene oxide sheets, inclusive of all values and ranges therebetween.

Combinations of the above-referenced ranges for the number of layers in the graphene oxide membrane 100 are also possible (e.g., at least about 100 to less than about 600, or at least about 300 to less than about 600), inclusive of all values and ranges therebetween.

In some embodiments, the graphene oxide membrane 100 can include about 100 to 600 layers of graphene oxide sheets, e.g., 200-500 layers, 200-400 layers, 200-300 layers, 200-250 layers, 300-600 layers, 300-500 layers, or 300-400 layers.

In some embodiments, the graphene oxide membrane 100 can have a thickness greater than or equal to about 25 nm, greater than or equal to about 50 nm, greater than or equal to about 0.1 microns, greater than or equal to about 0.15 microns, greater than or equal to about 0.2 microns, greater than or equal to about 0.3 microns, greater than or equal to about 0.4 microns, greater than or equal to about 0.5 microns, greater man or equal to about 0.75 microns, greater than or equal to about 1 micron, greater than or equal to about 2 microns. In some embodiments, the thickness of the graphene oxide membrane 100 may be less than or equal to about 5 microns, less than or equal to about 1 micron, less than or equal to about 0.75 microns, less than or equal to about 0.5 microns.

Combinations of the above-referenced ranges for the thickness of the graphene oxide membrane 100 are also possible (e.g., greater than or equal to about 25 nm to less than or equal to about 5 microns, greater than or equal to about 0.15 microns to less than or equal to about 0.5 microns).

In some embodiments, embodiments, the graphene oxide membrane 100 can have an average pore size of greater than or equal to about 0.5 nm, greater than or equal to about 1 nm, greater than or equal to about 2 nm, greater than or equal to about 3 nm, greater than or equal to about 4 nm, or greater than or equal to about 5 nm. In some embodiments, the graphene oxide membrane 100 can have an average pore size of less than or equal to about 6 nm, less than or equal to about 5 nm, less than or equal to about 4 nm, less than or equal to about 3 nm, or less than or equal to about 2 nm, inclusive of all values and ranges therebetween.

Combinations of the above-referenced ranges for the average pore size are also possible (e.g., greater than or equal to about 0.5 nm to less than or equal to about 6 nm, greater than or equal to about 1 nm to less than or equal to about 6 nm). In some embodiments, the graphene oxide membrane 100 can have an average pore size of about 0.5 nm, about 0.8 nm, about 1 nm, about 2 nm, about 3 nm, about 4 nm, about 5 nm, or about 6 nm.

In some embodiments, the graphene oxide sheets 110 can be arranged and oriented generally parallel to each other.

The spacing between the graphene oxide sheets 110 can be either interlayer spacing or intralayer spacing. The spacing between the graphene oxide sheets 110 can be engineered to control the molecular weight cutoff of the graphene oxide membrane 100.

In some embodiments, the chemical spacer 120 can form a covalent bond with an oxygen-containing functional group on the graphene oxide sheet 110. For example, the chemical spacer 120 can form a covalent bond with the epoxide groups, carboxylic groups or hydroxyl groups on the graphene oxide. In some embodiments, the chemical spacer 120 can also form a covalent bond with a non-oxygen-containing group (e.g., amine) on the graphene oxide sheet 110.

In some embodiments, the chemical spacer 120 can form a noncovalent interaction with an adjacent graphene oxide sheet 110 through a variety of mechanisms. In some embodiments, the chemical spacer 120 can be coupled to the adjacent graphene oxide sheet 110 through an ionic interaction. In some embodiments, the chemical spacer 120 can be coupled to the adjacent graphene oxide sheet 110 through hydrogen bonding. In some embodiments, the chemical spacer 120 can be coupled to the adjacent graphene oxide sheet 110 through one or more Van der Waals forces. In some embodiments, the chemical spacer 120 can be coupled to the adjacent graphene oxide sheet 110 through one or more x-effects. In some embodiments, the chemical spacer 120 can be coupled to the adjacent graphene oxide sheet 110 through the hydrophobic effect.

In some embodiments, the chemical spacer 120 can include an amine or a derivative thereof. In some embodiments, the chemical spacer 120 can have the structure in accordance with Formula I:

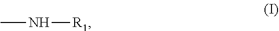

wherein: R₁ is an aryl or heteroaryl, which can be optionally substituted. In some embodiments, R₁ is

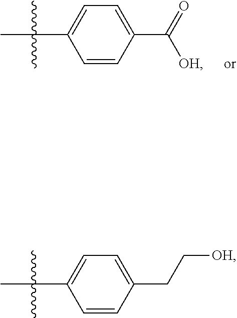 [SMILES: *c1ccc(C(=O)O)cc1 ; *c1ccc(CCO)cc1]

where [symbol] denotes the point of coupling with —NH.

In some embodiments, the chemical spacer 120 can include 4-aminophenylacetic acid, 2-(4-aminophenyl) ethanol, 2-(4-aminophenyl) propanol, 2-(4-aminophenyl) butanol, or any combination thereof.

In some embodiments, the chemical spacer 120 can include an amide or a derivative thereof. In some embodiments, the chemical spacer 120 can include the structure in accordance with Formula II:

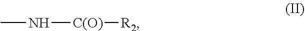

wherein: R₂ is a C₁-C₁₀ alkyl or a C₂-C₁₀ alkenyl, each of which can be optionally substituted. In some embodiments, R₂ is a C₁-C₈ alkyl, C₁-C₆ alkyl, C₂-C₈ alkenyl, or C₂-C₆ alkenyl. In some embodiments, non-limiting examples of R₂ can include methyl, ethyl, n-propyl, isopropyl, n-butyl, isobutyl, sec-butyl, tert-butyl, pentyl, hexyl, heptyl, octyl, nonyl, decyl, ethenyl, propenyl, and butenyl.

In some embodiments, the chemical spacer 120 can include acrylamide, propionamide, isobutyramide, pivalamide, or any combination thereof.

In some embodiments, the chemical spacer 120 can include a carbamate or a derivative thereof. In some embodiments, the chemical spacer 120 can include the structure in accordance with Formula IIa:

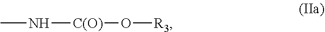

wherein: R₃ is a C₁-C₁₀ alkyl, a C₂-C₁₀ alkenyl, C₄-C₁₀ heterocycloalkyl, C₄-C₁₀ cycloalkyl, alkylaryl, aryl, or heteroaryl, each of which can be optionally substituted. In some embodiments, R₃ is a C₁-C₅ alkyl, C₁-C₆ alkyl, C₂-C₈ alkenyl, C₂-C₆ alkenyl, phenyl, or methylphenyl. In some embodiments, R₃ is methyl, ethyl, n-propyl, isopropyl, n-butyl, isobutyl, sec-butyl, tert-butyl, pentyl, hexyl, heptyl, octyl, nonyl, decyl, ethenyl, propenyl, or butenyl.

In some embodiments, non-limiting examples of the chemical spacer 120 can include methyl carbamate, ethyl carbamate, propyl carbamate, butyl carbamate, tert-butyl carbamate, phenyl carbamate, and benzyl carbamate.

In some embodiments, the weight ratio of graphene oxide sheets 110 to chemical spacer 120 in the graphene oxide membrane 100 can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of graphene oxide sheets 110 to chemical spacer 120 in the graphene oxide membrane 100 can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

In some embodiments, the atomic percent (at %) content of nitrogen present on the surface of the graphene oxide membrane 100 measured by X-Ray photoelectron spectroscopy can be less than about 5.0 at %, less than about 4.5 at %, less than about 4.0 at %, less than about 3.5 at %, less than about 3.2 at %, less than about 3.0 at %, less than about 2.8 at %, less than about 2.6 at %, less than about 2.4 at %, less than about 2.2 at %, less than about 2.0 at %, inclusive of all values and ranges therebetween. In some embodiments, the atomic percent (at %) content of nitrogen present on the surface of the graphene oxide membrane 100 measured by X-Ray photoelectron spectroscopy can be at least about 0.6 at %, at least about 1.1 at %, at least about 1.2 at %, at least about 1.3 at %, at least about 1.4 at %, at least about 1.5 at %, at least about 1.6 at %, at least about 1.8 at %, at least about 2.0 at %, inclusive of all values and ranges therebetween.

Combinations of the above referenced ranges for the at % content of nitrogen are also possible (e.g., at least about 0.6 at % to less than about 5.0 at %, or at least about 1.1 at % to less than about 3.2 at %).

In some embodiments, the atomic percent (at %) content of carbon present on the surface of the graphene oxide membrane 100 measured by X-Ray photoelectron spectroscopy can be less than about 80%, less than about 78%, less than about 75%, inclusive of all values and ranges therebetween. In some embodiments, the at % content of carbon present on the surface of the graphene oxide membrane 100 measured by X-Ray photoelectron spectroscopy can be at least about 50%, at least about 55%, or at least about 60%, inclusive of all values and ranges therebetween.

Combinations of the above referenced ranges for the at % content of carbon are also possible (e.g., at least about 50% to less than about 80%, or at least about 60% to less than about 75%). In contrast, existing graphene oxide membranes that are deliberately or unintentionally reduced often have at % content of carbon greater than 80% or even greater than 95%.

As described above with reference to FIG. 1C, in some embodiments the graphene oxide sheets 110 can optionally be coupled to an adjacent graphene oxide sheet 110 via at least one chemical linker 130. In some embodiments, the graphene oxide sheets 110 can be arranged and oriented generally parallel to each other and each of the graphene oxide sheets 110 can be coupled to an adjacent graphene oxide sheet 110 via a chemical linker 130.

The chemical linker 130 can be either linear or branched. In some embodiments, the chemical linkers 130 coupling adjacent graphene oxide sheets 110 can include a combination of linear and branched structures. In some embodiments, the length of the chemical linker 130 may be selected to impart desirable properties and/or control the spacing between the graphene oxide sheets 110. The spacing between the graphene oxide sheets 110 can be either interlayer spacing or intralayer spacing. The spacing between the graphene oxide sheets 110 can be engineered to control the molecular weight cutoff of the graphene oxide membrane 100.

The chemical linker 130 can have at least two ends that are coupled to adjacent graphene oxide sheets 110. For example, as shown in FIG. 1C, the chemical linker can include a first end 132 coupled to a first chemical spacer on a first graphene oxide sheet and a second end 134 coupled to a second chemical spacer on a second graphene oxide sheet. The first end 132 can be coupled to the first chemical spacer through a covalent bond or a noncovalent interaction. The second end 134 can be coupled to the second chemical spacer through a covalent bond or a noncovalent interaction. In some embodiments, an end of the chemical linker 130 (e.g., the first end 132, the second end 134, or another end) may be dangling, i.e., not coupled to anything.

In some embodiments, the chemical linker 130 can form a covalent bond with the oxygen-containing functional groups on the chemical spacer 120. For example, the chemical linker 130 can form a covalent bond with an epoxide group, a carboxylic group, or a hydroxyl group on the chemical spacer 120. In some embodiments, the chemical linker 130 can also form a covalent bond with a non-oxygen-containing group (e.g., amine) on the chemical space 120. In some embodiments, the chemical linker 130 can also form a covalent bond with a carbon atom on the chemical spacer 120.

The combination of the chemical spacer 120 and the chemical linker 130 that is coupled thereto is referred to herein as the crosslinker 140.

In some embodiments, the crosslinker 140 can have a structure in accordance with Formula III:

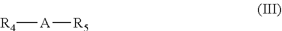

wherein: A is absent, aryl, heteroaryl, C₁-C₁₀ alkylene linker, C₂—C₁₀ alkenylene linker, or (—CH₂—CH₂—O—)ₚ (p=₁ to ₅), each of which can be optionally substituted; and
R₄ and R₅ are independently selected from C₁—C₁₀ alkyl, C₁-C₁₀ alkenyl, C₁-C₁₀ hydroxyalkyl, —C₀-C₆ alkyl—C(O)—O—Co—C₆ alkyl, —C(O)—O—C₁-C₁₀ alkyl, —C₀-C₆ alkyl—C(O)—S—C₀-C₆ alkyl, —C(O)—S—C₁-C₁₀ alkyl, —C₀-C₆ alkyl—O—C₀-C₆ alkyl, —O—C₁-C₁₀ alkyl, —C₀-C₆ alkyl—S—C₀-C₆ alkyl, —S—C₁-C₁₀ alkyl, —C₀-C₆ alkyl—NH—C₀-C₆ alkyl, —NH—, —NH—(C₁-C₁₀ alkyl)₂, —NH—C₁-C₁₀ alkyl, —C₀-C₆ alkyl—NH—C(O)—C₀-C₆ alkyl, —NH—C(O)—C₁-C₁₀ alkyl, and (—CH₂—CH₂—O—)ₚ (p=1 to 5), each of which can be optionally substituted, wherein one end of each of R₄ and R₅ can be optionally coupled to a graphene oxide sheet. In some embodiments, the alkyl, alkenyl, or hydroxyalkyl in R₄ and/or R₅ can be optionally coupled to a graphene oxide sheet.

In some embodiments, A is phenyl, biphenyl, naphthyl, or

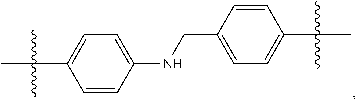 [SMILES: *c1ccc(CNc2ccc(*)cc2)cc1]

where [symbol] denotes the point of coupling with R₄ or R₅.

In some embodiments, A is a C₁-C₆ alkylene linker or a C₂-C₆ alkenylene linker, each of which can be optionally substituted.

In some embodiments, A is absent.

In some embodiments, R₄ and R₅ independently includes an ether, amine, amide, thioether, or a combination thereof.

In some embodiments, R₄ and R₅ are independently selected from —(CH₂)₁₋₁₀O—, —(CH₂)₁₋₁₀OC(O)—, —(CH₂)₀₋₆—NH—C(O)—(CH₂)₀₋₆—, —(CH₂)₀₋₆—O—(CH₂)₀₋₆—, —(CH₂)₀₋₆—S—(CH₂)₀₋₆—, or —NH—, each of which can be optionally substituted.

In some embodiments, R₄ and R₅ are independently C₁-C₁₀ hydroxyalkyl, which can be optionally substituted, and the hydroxyalkyl can be optionally coupled to a graphene oxide sheet.

In some embodiments, R₄ and R₅ are independently —NH—, —NH—C(O)—, —NH—C(O)—(CH₂)₂—O—, —CH₂—NH—phenyl—HN—C(O)—, —CH₂—S—(CH₂)₂—NH—C(O)—, or —CH₂—O—C(O)—.

In some embodiments, R₄ and R₅ are independently —C₁-C₆ alkyl-O—C₁-C₆ alkyl, which can be optionally substituted, and the alkyl can be optionally coupled to a graphene oxide sheet.

In some embodiments, R₄ and R₅ are independently —NH—C(O)—C₁-C₁₀ alkyl, which can be optionally substituted, and the alkyl can be optionally coupled to a graphene oxide sheet. For example, R₄ and R₅ can be independently —NH—C(O)—(CH₂)_{q}—O—(q=1 to 10).

In some embodiments, the crosslinker 140 can have a structure in accordance with Formula IIIa:

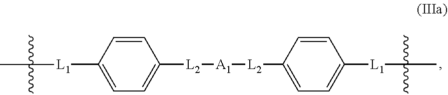

wherein:
L₁ is selected from —NH—, —C(═O)—NH—, or absent;
L₂ is selected from absent, —C(═O)—NH—(CH₂)ₙ—, —(CH₂)₂—O—(CH₂)ₙ—, or —NH—(CH₂)ₙ—;
A₁ is selected from absent, aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
n is 0-4; and [symbol]
denotes the point of coupling with a carbon atom on a graphene oxide sheet.

In some embodiments, Ai is phenyl. For example, the crosslinker 140 can have a structure in accordance with Formula IIIa-1:

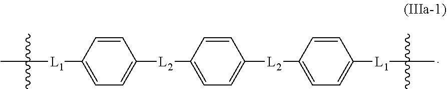

In some embodiments, A₁ is linear C₅ alkyl. In some embodiments, A₁ is linear C₆ alkyl.

In some embodiments, n is 0. In some embodiments, n is 1. In some embodiments, n is 2. In some embodiments, n is 3. In some embodiments, n is 4.

In some embodiments, the crosslinker 140 can have a structure in accordance with Formula IIIb:

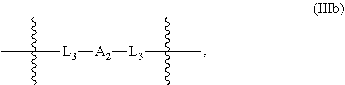

wherein:
L₃ is selected from —C(═O)—NH—(CH₂)ₘ—, —C(═O)—NH—C(═O)—(CH₃)₂—S—(CH₂)ₘ—, or —NH—C(═O)—(CH₃)₂—S—(CH₂)ₘ—;
A₂ is selected from aryl, heteroaryl, C₄-C₁₀ heterocycloalkyl, C₄-C₁₀ cycloalkyl, or C₄-C₁₀ alkyl, wherein the aryl, heteroaryl, heterocycloalkyl, cycloalkyl, and alkyl can each be optionally substituted by one or more substituents selected from halo, C₁-C₄ alkoxy, or C₁-C₄ alkyl;
m is 0-4; and [symbol]
denotes the point of coupling with a carbon atom on a graphene oxide sheet.

In some embodiments, A₂ is phenyl. For example, the crosslinker 140 can have a structure in accordance with Formula IIIb-1:

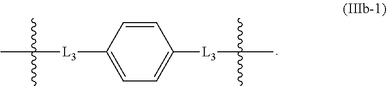

In some embodiments, A₂ is linear C₅ alkyl. In some embodiments, A₂ is linear C₆ alkyl.

In some embodiments, m is 0. In some embodiments, m is 1. In some embodiments, m is 2. In some embodiments, m is 3. In some embodiments, m is 4.

In some embodiments, the crosslinker 140 can have one of the following structures:

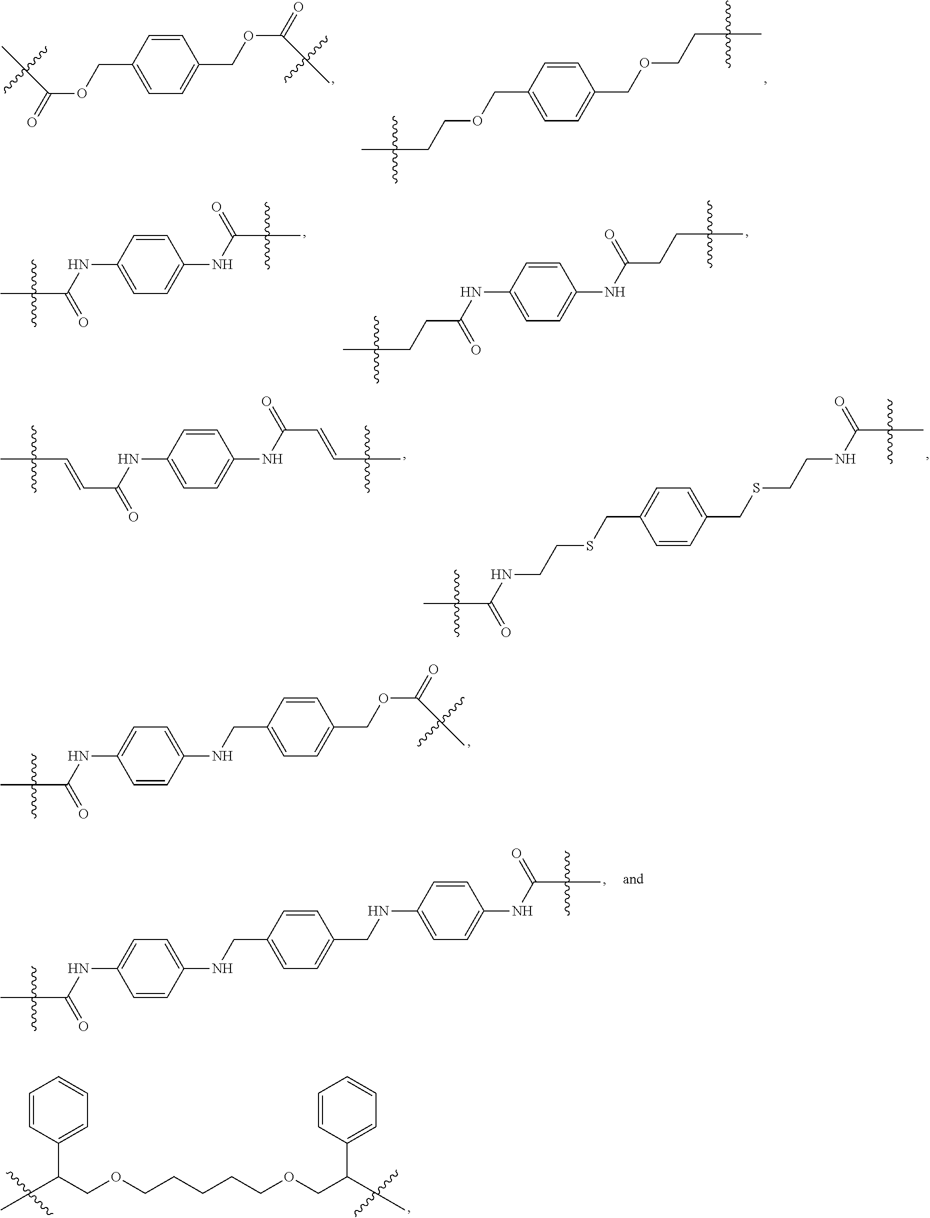

where [symbol] denotes the point of coupling with a graphene oxide sheet. Each of these crosslinkers can be optionally substituted.

In some embodiments, the chemical linker 130 can have one of the following structures:

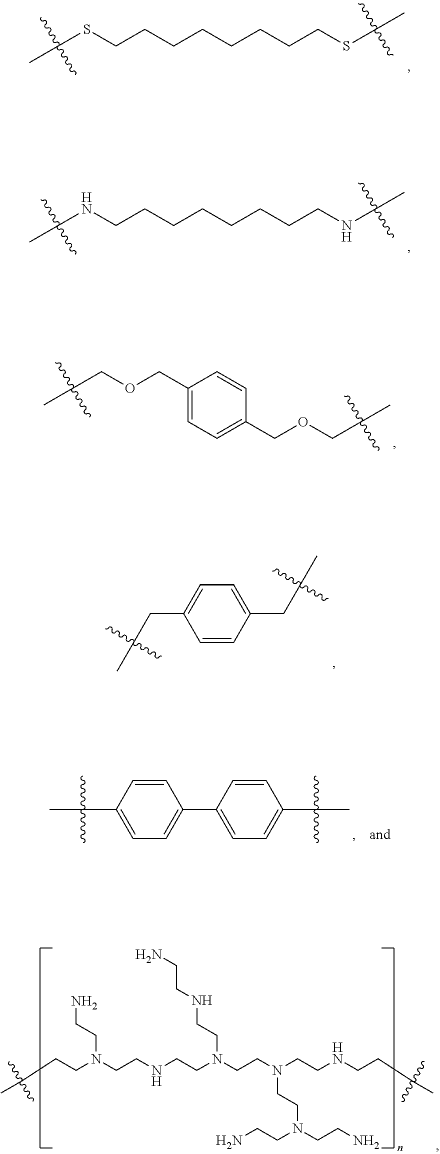

where: n is 1 to 5; [symbol] denotes the point of coupling to the chemical spacer 120.

Swelling of membranes can be problematic because it can adversely affect the structural integrity of the membrane, change the molecular weight cutoff, etc. Without being bound by any particular theory, it is believed that the interaction (e.g., van der Waals interactions) between the graphene oxide sheets 110 are relatively weak and certain solvents and/or solvents at certain temperatures enter into the region between the sheets and disrupt some of these interactions resulting in swelling and/or destabilization. The crosslinkers 140 may serve to stabilize the graphene oxide membrane 100 from destabilization in solvents and/or at elevated temperatures. In some embodiments, the crosslinker 140 may have a length and/or density that substantially reduces swelling of the graphene oxide membrane 100 in certain environments (e.g., solvents, elevated temperatures, etc.) and/or prevents destabilization of the graphene oxide membrane 100.

In some embodiments, the weight ratio of graphene oxide to crosslinker 140 in the finished membrane can be less than about 1,000, less than about 500, less than about 400, less than about 300, less than about 200, less than about 100, less than about 50, less than about 25, less than about 15, less than about 10, or less than about 5, inclusive of all values and ranges therebetween. In some embodiments, the weight ratio of graphene oxide to crosslinker 140 in the finished membrane can be at least about 5, at least about 10, at least about 15, at least about 20, at least about 25, at least about 30, at least about 35, at least about 40, at least about 45, or at least about 50, inclusive of all values and ranges therebetween.

Combinations of the above-referenced ranges for the weight ratio are also possible (e.g., at least about 5 to less than about 1000, or at least about 10 to less than about 200).

Some embodiments of the graphene oxide membrane 100 can be found in the disclosures of U.S. Pat. No. 11,097,227, titled, “Durable Graphene Oxide Membranes,” issued Aug. 24, 2021 (“the '227 patent”), and U.S. Pat. No. 11,123,694, titled, “Filtration Apparatus Containing Graphene Oxide Membrane,” issued Sep. 21, 2021 (“the '694patent”), which are incorporated herein by reference

In some embodiments, the graphene oxide membrane 100 can be and/or include an alkylated graphene oxide membrane disposed on the sulfonated support 200. In such embodiments, the alkylated graphene oxide membrane 100 can comprise a plurality of graphene oxide layers, each graphene oxide layer including at least one graphene oxide sheet covalently coupled to a chemical spacer, the chemical spacer being of Formula I:

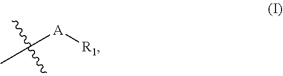

wherein:

### A is O, NH, or S;

R₁ is optionally substituted C₁-C₅ alkyl; and [symbol]
indicates a point of connection to a carbon atom on the graphene oxide sheet.

In some embodiments, A is O. In some embodiments, A is NH. In some embodiments, A is S.

In some embodiments, R₁ is optionally substituted C₂-C₅ alkyl. In some embodiments, R₁ is optionally substituted C₂-C₄ alkyl. In some embodiments, R₁ is optionally substituted C₃-C₅ alkyl. In some embodiments, R₁ is optionally substituted C₃-C₄ alkyl.

In some embodiments, R₁ is optionally substituted C₁ alkyl. In some embodiments, R₁ is optionally substituted C₂ alkyl. In some embodiments, R₁ is optionally substituted C₃ alkyl. In some embodiments, R₁ is optionally substituted C₄ alkyl. In some embodiments, R₁ is optionally substituted C₅ alkyl.

In some embodiments, R₁ is unsubstituted C₁ alkyl. In some embodiments, R₁ is unsubstituted C₂ alkyl. In some embodiments, R₁ is unsubstituted C₃ alkyl. In some embodiments, R₁ is unsubstituted C₄ alkyl. In some embodiments, R₁ is unsubstituted C₅ alkyl.

In some embodiments, R₁ is unsubstituted C₂—C₅ alkyl, e.g., —CH₂CH₃, —(CH₂)₂CH₃, —CH(CH₃)₂, —(CH₂)₃CH₃, —CH(CH₃)₂CH₂CH₃, —CH₂CH(CH₃)₂, —C(CH₃)₃, —(CH₂)₄CH₃, —C(CH₃)₂CH₂CH₃, —CH₂C(CH₃)₃, —(CH₂)₂CH(CH₃)₂, —CH(CH₃)(CH₂)₂CH₃, —CH(CH₂CH₃)₂, —CH(CH₃)CH(CH₃)₂, or —CH₂CH(CH₃)CH₂CH₃.

Some embodiments of the alkylated graphene oxide membrane 100 can be found in the disclosure of International Patent Application No. PCT/US2022/078051, titled Filtration Apparatus Containing Alkylated Graphene Oxide Membrane,” filed Oct. 13, 2022 (the '051 application), the disclosure of which is incorporated herein by reference.

FIG. 1A shows the sulfonated support 200 can be a substrate material that provides a surface on which the graphene oxide membrane 100 can be disposed. The sulfonated support 200 can act as a protective layer that prevents damage of the graphene oxide membrane 100 and other components of the filtration apparatus 1000. For example, the sulfonated support 200 can protect the graphene oxide membrane 100 from damage (e.g., formation of pinholes, punctures, cracks, or other mechanical stress-induce defects) resulting from the fabrication of spiral membranes, and/or the use of the filtration apparatus 1000 under harsh environment conditions (high pressure, highly alkaline conditions, extended periods of time, etc.). The sulfonated support 200 can be made of and/or include a material with a chemical structure comprising sulfate groups. The sulfate groups can impart hydrophilicity and/or hydrophilic character to the sulfonated support 200, resulting in high chemical affinity between the sulfonated support 200 and the graphene oxide membrane 100, particularly, with graphene oxide membranes 100 that include one or more hydrophilic chemical spacers. This high chemical affinity improves the adhesion and compatibility between the sulfonated support 200 and the graphene oxide membrane 100, which facilitates fabricating the filtration apparatus 1000 with few and/or limited number of defects. More specifically, the improved hydrophilicity of the sulfonated support 200 due to the presence of sulfate groups can facilitate adequately matching the hydrophilicity of solutions containing graphene oxide and/or other chemical species employed in the fabrication of the graphene oxide membrane 100. In that way, the sulfate groups in the sulfonated support 200 can facilitate the formation of a high-quality filtration apparatus 1000 with a graphene oxide membrane 100 free of defects (e.g., pinholes, flakes, air pockets, cracks, rough surface spots, etc.). The fabrication of the filtration apparatus 1000 with few and/or limited number of defects can also result in significant improvements in the performance (e.g., rejection rate and/or flux) of the filtration apparatus 1000, as further described herein.

In some embodiments, the sulfonated support 200 can have a thickness of no more than about 1200 μm, no more than about 1000 μm, no more than about 800 μm, no more than about 600 μm, no more than about 400 μm, no more than about 200 μm, nor more than about 100 μm, or no more than about 45 μm, inclusive of all values and ranges therebetween. In some embodiments, the sulfonated support 200 can have a thickness of at least about 75 μm, at least about 100 μm, or at least about 200 μm, inclusive of all values and ranges therebetween.

Combinations of the above referenced ranges for the thickness of the sulfonated support 200 are also possible (e.g., a thickness of at least about 75 μm to no more than about 1200 μm, at least about 100 μm to no more than about 1000 μm).

The porosity of the sulfonated support 200 can have an impact on the flux of the graphene oxide membrane 100. Specifically, a small average pore size can improve the flux and/or rejection rate of the graphene oxide membrane 100. For example, in some embodiments the sulfonated support 200 can have an average pore size of less than about 1 μm, less than about 800 nm, less than about 600 nm, less than about 400 nm, less than about 200 nm, less than about 100 nm, less than about 100 nm, less than about 50 nm, less than about 25 nm, less than about 20 nm, less than about 15 nm, less than about 10 nm, less than about 5 nm, less than about 2 nm or less than about 1 nm. In some embodiments, the sulfonated support 200 can have an average pore size of at least about 1 nm, at least about 5 nm, at least about 8 nm, at least about 10 nm, at least about 20 nm, at least about 50 nm, at least about 75 nm, least about 100 nm, at least about 250 nm, at least about 500 nm, at least about 750 nm, at least about 1 μm, inclusive of all values and ranges therebetween.

The roughness of the sulfonated support 200 can have an impact on the flux of the graphene oxide membrane 100. Specifically, a smooth sulfonated support 200 can improve the flux and/or rejection rate of the graphene oxide membrane 100 as compared to a rough sulfonated support 200. Accordingly, in some embodiments, the sulfonated support 200 can be smooth. For example, the sulfonated support 200 can have a root mean squared surface roughness of less than about 3 μm, less than about 2.5 μm, less than about 2 μm, less than about 1.5 μm, or less than about 1 μm. In some embodiments, the sulfonated support 200 can have a root mean squared surface roughness of at least about 1 μm, at least about 1.2 μm, at least about 1.4 μm, at least about 1.5 μm, inclusive of all values and ranges therebetween. In some embodiments, the surface roughness is measured by a Dektak 6M Contact Profilometer.

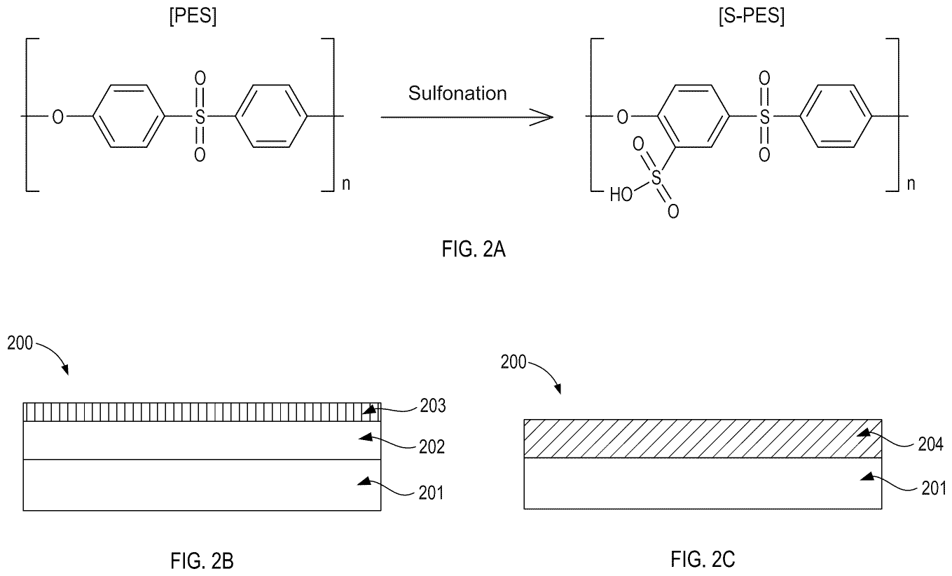

In some embodiments the sulfonated support 200 can be made of and/or include a polymer functionalized by incorporation of sulfate groups chemically bonded to the polymeric main chains and/or to side chains. For example, as shown in FIG. 2A, in some embodiments the sulfonated support 200 can be made of and/or include a polyethersulfone (PES) material that has been functionalized by one or more sulfonation reaction(s) to produce a sulfonated polyethersulfone (S-PES) polymer. The S-PES polymer incorporates sulfate groups chemically bonded to alternating benzene rings in the PES main and/or backbone chain. In other embodiments, the sulfonated support can be made of and/or include a sulfonated polypropylene, a sulfonated polystyrene, a sulfonated polyethylene, a sulfonated polysulfone, and/or a sulfonated tetrafluoroethylene.

In some embodiments, the sulfonated support 200 can be and/or include a non- woven fiber or polymeric membrane including the S-PES polymer. In some embodiments, the sulfonated support 200 can be a polymeric membrane made entirely of S-PES polymer. In some embodiments, the sulfonated support 200 can be a multilayer polymeric membrane including S-PES polymer and other polymeric materials. For example, in some embodiments the sulfonated support 200 can be a multilayer polymeric membrane including an S-PES polymer layer, and one or more additional layers, including a backing layer, coupled to and/or disposed on one side of the S-PES polymer layer. In such embodiments, the one or more additional layers and/or backing layers can include, for example, polypropylene (PP), polystyrene, polyethylene, polyethylene oxide, polytetrafluoroethylene (PTFE), polyvinylidene fluoride, polymethylmethacrylate, polydimethylsiloxane, polyester, polyolefin, cellulose, cellulose acetate, cellulose nitrate, polyacrylonitrile, glass fiber, quartz, alumina, silver, polycarbonate, nylon, Kevlar or other aramid, or polyether ether ketone.

In some embodiments the sulfonated support 200 can include two or more layers. For example, the sulfonated support 200 can include a first layer and a second layer, the first layer can be made of and/or include S-PES polymer and be disposed on the second layer, wherein the first layer and the second layer have different average pore sizes. In some embodiments, the graphene oxide membrane 100 is disposed on the first layer, and the first layer has a smaller average pore size than the second layer. In some embodiments, the sulfonated support 200 can be a multilayer material including a thick backing layer, one or more intermediate layer(s) and/or interlayer(s), and one top layer. For example, FIG. 2B shows a schematic illustration of a sulfonated support 200 including a backing layer 201, one or more interlayer(s) 202, and a top layer 203. The backing layer 201 can be a thick layer made of any suitable backing material, including those described above. The backing layer 201 can be sized and shaped to exhibit sufficient strength and/or other mechanical properties that impart durability to the sulfonated support 200. The one or more interlayer(s) 202 can be disposed between the backing layer 201 and the top layer 203. In some embodiments, the interlayer(s) 202 can be made entirely of PES. Alternatively, in other embodiments the interlayer 202 can include at least one PES layer stacked with one or more layers made of other polymeric materials. In some embodiments, the interlayer 202 can display chemical and/or physical properties that facilitate adhering, combining, integrating, and/or incorporating the top layer 203 to the backing layer 201. For example, in some embodiments the interlayer 202 can exhibit chemical affinity to the backing layer 201 and the top layer 203, which enables coupling the backing layer 201 to the top layer 203. In some embodiments, the interlayer 202 can have a thermal expansion coefficient that matches closely the thermal expansion coefficient of the backing layer 201 as well as that of the top layer 203 (e.g., a thermal expansion coefficient intermediate between that of the backing layer 201 and the top layer 203), such that the sulfonated support 200 can withstand high temperatures without undergoing delamination due to thermal expansion mismatch. The top layer 203 can be a thin layer disposed on the interlayer and made entirely of S-PES, or an S-PES containing material.

FIG. 2C shows a schematic illustration of a sulfonated support 200 according to an embodiment. The sulfonated support 200 shown in FIG. 2C can be a multilayer material that includes a backing layer 201 similar to the backing layer described above with reference to FIG. 2B, and a blended top layer 204. The blended top layer 204 can be a PES layer that has been functionalizing via sulfonation reactions such as those described in FIG. 2A, to produce a S-PES/PES blend or mixture. In some embodiments, a fraction and/or percentage of the blended top layer 204 can be made of S-PES polymer formed and/or fabricated by incorporation of sulfate groups chemically bonded to alternating benzene rings in the PES backbone chain.

To improve the filtration apparatus 1000 durability under high pressure operation, e.g., about 500 psi to 1600 psi or greater, in some embodiments, the sulfonated support 200 can have a Young's modulus of no more than about 4,000 MPa, no more than about 3,000 MPa, no more than about 2,000 MPa, no more than about 1,000 MPa, no more than about 800 MPa, no more than about 700 MPa, no more than about 600 MPa, no more than about 500 MPa, no more than about 400 MPa, no more than about 300 MPa, or no more than about 200 MPa, inclusive of all values and ranges therebetween. In some embodiments, the sulfonated support 200 can have a Young's modulus of at least about 200 MPa, at least about 250 MPa, at least about 300 MPa, at least about 450 MPa, at least about 550 MPa, at least about 650, at least about 750 MPa, at least about 850 MPa, at least about 950 MPa, at least about 1000 MPa, at least about 1500 MPa, at least about 2500 MPa, at least about 3500 MPa, or at least about 4500 MPa, inclusive of all values and ranges therebetween.

In some embodiments, the sulfonated support 200 can have a molecular weight cutoff of about 400 Da. In some embodiments, the sulfonated support 200 can have a molecular weight cutoff of about 500 Da. In some embodiments, the sulfonated support 200 can have a molecular weight cutoff of about 600 Da. In some embodiments, the sulfonated support 200 can have a molecular weight cutoff of about 700 Da. In some embodiments, the sulfonated support 200 can have a molecular weight cutoff of about 1 kDa. In some embodiments, the sulfonated support 200 can have a molecular weight cutoff of about 2 kDa. In some embodiments, the sulfonated support 200 can have a molecular weight cutoff of about 5 kDa. In some embodiments, the sulfonated support 200 can have a molecular weight cutoff of about 10 kDa. In some embodiments, the sulfonated support 200 can have a molecular weight cutoff of about 25 kDa. In some embodiments, the sulfonated support 200 can have a molecular weight cutoff of about 50 kDa. In some embodiments, the sulfonated support 200 can have a molecular weight cutoff of about 100 kDa. In some embodiments, the sulfonated support 200 can have a molecular weight cutoff of about 200 kDa. In some embodiments, the sulfonated support 200 can have a molecular weight cutoff of about 400 kDa. In some embodiments, the sulfonated support 200 can have a molecular weight cutoff of about 500 kDa.

The sulfonated support 200 made of and/or including the S-PES polymer can be referred to herein as an S-PES sulfonated support 200. As described above, the S-PES sulfonated support 200 incorporates sulfate groups chemically bonded to alternating benzene rings in the PES backbone chain. These sulfate groups impart hydrophilicity and/or a hydrophilic character to the S-PES sulfonated support 200, causing the S-PES sulfonated support 200 to exhibit high affinity towards graphene oxide membranes 100 that include hydrophilic chemical spacers. For example, in some embodiments the S-PES sulfonated support 200 can exhibit high chemical affinity towards a graphene oxide membrane 100 comprising hydrophilic chemical spacers such as acrylamide, propionamide, isobutyramide, pivalamide, or any combination thereof.

In some embodiments, the S-PES sulfonated support 200 can exhibit high chemical affinity towards a graphene oxide membrane 100 which comprises chemical spacers having chemical functionalities that impart hydrophilic character. For example, in some embodiments the S-PES sulfonated support 200 can exhibit high chemical affinity towards graphene oxide membranes 100 comprising chemical spacers with functionalities such as allyl amine, ethylene glycol (PEG), hydroxypropyl methyl cellulose (HPMC), acrylamide dopamine, sodium styrene sulfonate, ethyleneimine, cyclic carboxylic and/or sulfonic acid. In some embodiments, the S-PES sulfonated support 200 can exhibit high chemical affinity towards graphene oxide membranes 100 comprising hydrophilic amine chemical spacers having a chemical structure in accordance with the Formula I (e.g., —NH—R₁) described above. For example, in some embodiments the S-PES sulfonated support 200 can exhibit high chemical affinity towards graphene oxide membranes 100 comprising hydrophilic amine chemical spacers such as 4-aminophenylacetic acid, 2-(4-aminophenyl) ethanol, 2-(4-aminophenyl) propanol, 2-(4-aminophenyl) butanol, or any combination thereof.

In some embodiments, the S-PES sulfonated support 200 can exhibit high chemical affinity towards graphene oxide membranes 100 comprising hydrophilic amide chemical spacers having a chemical structure in accordance with the Formula II (e.g., —NH—C(O)—R₂) described above. For example, in some embodiments the S-PES sulfonated support 200 can exhibit high chemical affinity towards graphene oxide membranes 100 comprising hydrophilic amide chemical spacers such as acrylamide, propionamide, isobutyramide, pivalamide, or any combination thereof

In some embodiments, the S-PES sulfonated support 200 can exhibit high chemical affinity towards graphene oxide membranes 100 which have been functionalized with carboxylic groups as described by references Sydlik, S. A. & Swager, T. M., “Functional Graphenic Materials Via a Johnson-Claisen Rearrangement,” Adv. Funct. Mater. 23, 1873- 1882 (2012); and Collins, W. R., et al., “Rearrangement of Graphite Oxide: A Route to Covalently Functionalized Graphenes,” Angew. Chem., Int. Ed. 50, 8848-8852 (2011), the contents of each of which are incorporated by reference.

In some embodiments, the-PES sulfonated support 200 can exhibit high chemical affinity towards graphene oxide membranes 100 which have functionalized with hydroxyl groups, as described above. For example, graphene oxide membranes 100 which have been allowed to react with epoxide reagents including, but not limited to 1-2-epoxypropane, styrene oxide, ethylene oxide, epichlorohydrine, 1,2-epoxybutane, bisphenol, A diglycidyl ether, 1, 3-butadiene diepoxide and 1,2,7,8-diepoxyoctane, to produce graphene oxide membranes 100 bearing hydrophilic hydroxyl groups.

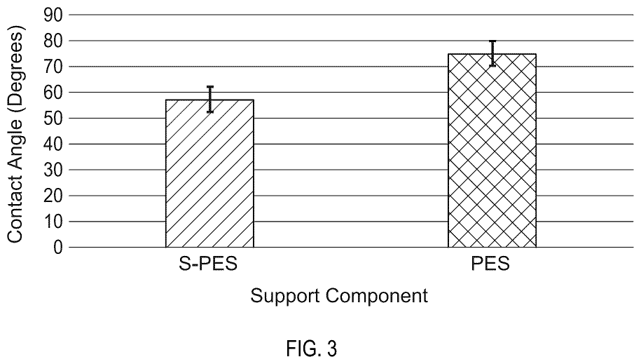

As described above, the sulfate groups in the sulfonated support 200 can impart hydrophilicity and/or a hydrophilic character to the sulfonated support 200. The hydrophilicity and/or hydrophilic character can be evidenced by measuring the water contact angle of the sulfonated support 200. In general, materials that exhibit hydrophilicity and/or hydrophilic character have water contact angles smaller than 90 degrees, while materials that exhibit hydrophobicity and/or hydrophobic character have water contact angles higher than 90 degrees. FIG. 3 shows the water contact angle measured for a PES support (UP010P, Microdyn M+H) and a S-PES sulfonated support 200 using a Rame-hart Model 90 CA Goniometer. The S-PES sulfonated support 200 described in FIG. 3 includes a thick backing layer, one or more interlayer(s), and a top layer, similar in structure to the S-PES sulfonated support 200 described with reference to FIG. 2B. The contact angles reported in FIG. 3 were recorded by averaging 9 different samples. FIG. 3 shows the S-PES sulfonated support 200 has an average contact of 57.3 degrees, with a standard deviation of 9.0 degrees, and the PES support has an average contact of 75.0 degrees, with a standard deviation of 1.7 degrees. The smaller contact angle of the S-PES sulfonated support with respect to the PES support provides evidence of the increased hydrophilicity and/or increased hydrophilic character of the S-PES sulfonated support 200 resulted from functionalization of the PES polymer with sulfate groups chemically bonded to alternating benzene rings in the PES main and/or backbone chain.

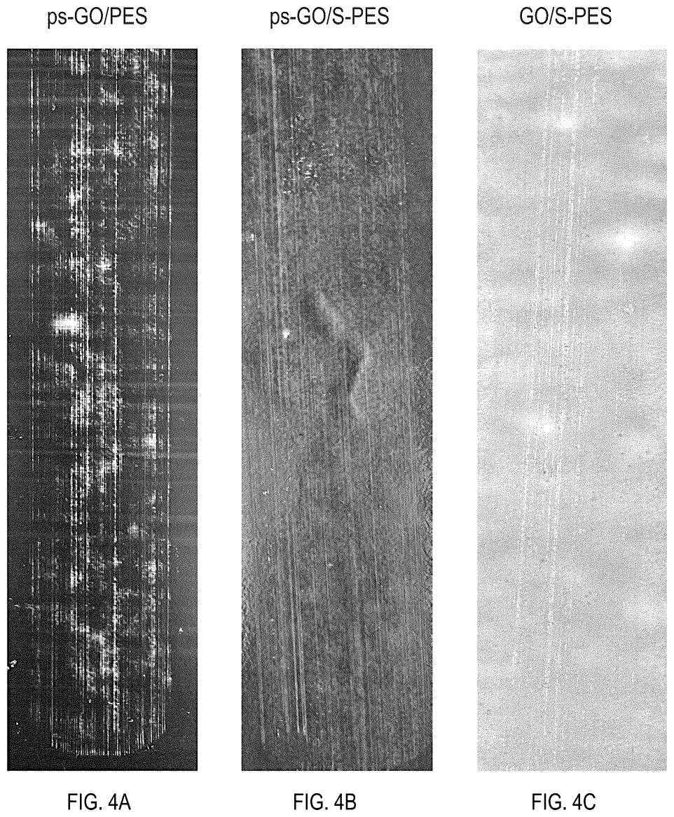

FIGS. 4A-4C show images of a various graphene oxide membranes 100 collected after conducting a crockmeter test with a PES support (UP010P, Microdyn M+H) and S-PES sulfonated support 200 (HYDRACoRe70pHT, Hydranautics) similar in structure to the S-PES sulfonated support 200 shown in FIG. 2B. The crockmeter test is designed to simulate a rubbing action generated by a probe against a sample coating, with the purpose of evaluating the amount of material transferred and/or removed from the sample coating due to the rubbing action. The crockmeter test can be used to assess the adhesion of the graphene membrane 100 and the sulfonated support 200. During the test, a sample graphene oxide membrane 100 disposed on a sulfonated support 200 is positioned and secured on a base of the crockmeter. The sample can be secured to the base using clamps and/or a metal plate. A motorized arm is connected to a probe made of a standardized material (ISO Crock Square ISO 105 F09). The motorized arm is programmed to position the probe at an origin and/or starting position, and then move the probe in a straight line from the starting position to an end position located at a distance of 101.0 mm (4 inches), and then back to the starting position, while exerting on the sample a constant force of 9 Newtons. Each movement of the probe from the starting position to the end position and then back to the starting position under constant load is referred to as one swipe.

FIG. 4A shows an image of a sample graphene oxide membrane 100 comprising a propionamide chemical spacer disposed on a PES support (ps-GO/PES), recorded after conducting the crockmeter test for 1 swipe. FIG. 4A shows multiple textured features (e.g., scratches) indicating that a significant amount of the ps-GO membrane 100 has been transferred and/or removed from the PES support after 1 single swipe of the crockmeter test. FIGS. 4B and 4C show images of a ps-GO membrane 100 disposed on an S-PES sulfonated support 200 (ps-GO/S-PES); and a graphene oxide membrane 100 without a chemical spacer disposed on an S-PES sulfonated support 200 (GO/S-PES), respectively. FIGS. 4B and 4C reveal a small number of textured features (e.g., scratches), indicating that small amounts of the ps-GO and GO membrane 100 have been transferred and/or removed from the S-PES sulfonated support 200 after 10 swipes of the crockmeter test. Comparison of the textured lines in FIG. 4A with the textured features in FIGS. 4B and 4C provide evidence that the S-PES sulfonated support 200 exhibits improved adhesion to the ps-GO and GO membrane 100 with respect to the PES support. Without being bound by any particular theory, it is believed that the increased hydrophilicity of the S-PES sulfonated support 200 facilitates adequately matching the hydrophilicity of the casting solutions containing graphene oxide which are used during the fabrication of the filtration apparatus 1000. Consequently, when a graphene oxide solution is first casted onto the S-PES sulfonated support layer, the solution can penetrate beyond the surface of the S-PES sulfonated support 200 and subsequently solidify around and/or near the surface of the S-PES sulfonated support 200, providing mechanical interlocking between the graphene oxide membrane 100 and the sulfonated support 200.

Furthermore, comparison of FIGS. 4B and 4C reveals that the textured features (e.g., scratches) observed in FIG. 4C are deeper than longer that those observed in FIG. 4B, indicating that a greater amount of GO membrane 100 has been transferred and/or removed from the S-PES sulfonated support 200 after 10 swipes of the crockmeter test, when compared to the amount of ps-GO membrane 100 transferred and/or removed from the S-PES sulfonated substrate 200. This result highlights the further adhesion improvements observed with the S-PES sulfonated support 200 and a graphene oxide membrane 100 which comprises a hydrophilic chemical spacer (e.g., ps-GO) with respect to a graphene oxide membrane 100 which does not comprise a hydrophilic chemical spacer (e.g., GO).

As described above, the improved adhesion between the graphene oxide membrane 100 and the sulfonated support 200 can have an impact on the filtration apparatus 1000 durability. With poor adhesion, the graphene oxide membrane 100 can be easily damaged through physical handling and during process filtration. A graphene oxide membrane 100 which exhibits greater levels of adhesion to the sulfonated support 200 is more resilient to physical and chemical delamination. Damaged membranes leave behind an uncoated substrate that will come in direct contact with process fluid, which can lead to higher levels of fouling, shortened lifetime, and overall deficient filtration apparatus 1000 performance.

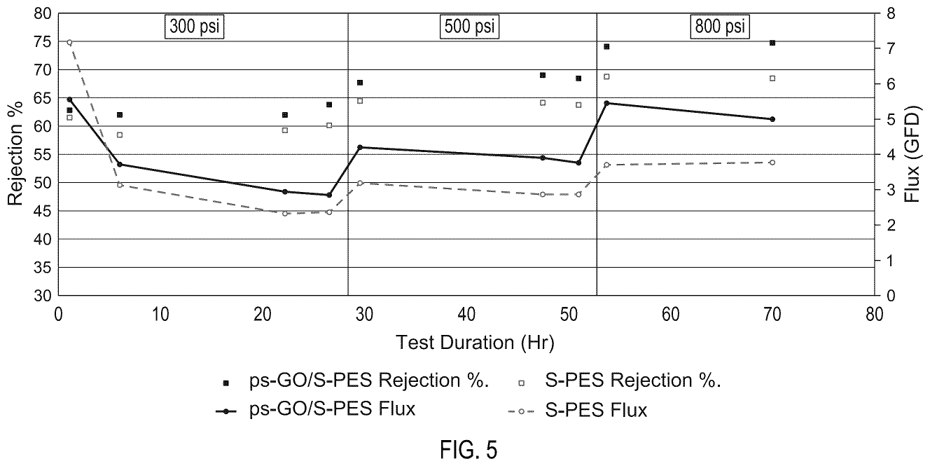

The performance of the filtration apparatus 1000 described herein can be characterized by the rejection rates for specific solute species. FIG. 5 shows the water flux (in gal/ft² day, or GFD) and the rejection rate (%) of a filtration apparatus 1000 including a ps-GO membrane disposed on an S-PES sulfonated support 200 (ps-GO/S-PES trace), and an S-PES sulfonated support 200 without a graphene oxide membrane (S-PES trace). The S-PES sulfonated support 200 described with reference to FIG. 5 includes a thick backing layer, one or more intermediate layer(s) and/or interlayer(s), and one top layer, similar in structure to the S-PES sulfonated support 200 shown in FIG. 2B. The rejection rates described herein were measured using a crossflow filtration cell, flowing a Weak Black Liquor solution (WBL) at a flow rate of 0.237 gal per minute, a temperature of 50° C., and a pressure of 300, 500 and 800 psi. The WBL solution comprises sodium sulfate, sodium carbonate, sodium hydrosulfide, sodium thiosulfate, sodium hydroxide, as well as larger size organic species including hemicellulose, cellulose, and lignin, as further described herein. The rejection rate for the solute species included in the WBL solution was measured by refractive index (RI) method in Degrees Brix. The rejection was calculated as calculated as

$$rejection rate = \frac{1 - Permeate RI}{Feed RI} \times 10 \; 0 .$$

FIG. 5 facilitates comparing the performance of the S-PES sulfonated support 200 by itself (e.g., no graphene oxide included) with that of a filtration apparatus 1000 including the S-PES sulfonated support 200 coupled to a ps-GO membrane (e.g., a graphene oxide membrane comprising a hydrophilic propionamide chemical spacer). FIG. 5 shows the S-PES sulfonated support 200 displayed an initial flux of about 7.2 GFD which rapidly decreased during the first 8 hours of continuous operation at 300 psi until reaching a relatively steady flux of about 2.4 GFD. The ps-GO/S-PES filtration apparatus 1000 displayed an initial flux of about 5.5 GFD, which corresponds to a 26.3% decrease in initial flux with respect to the S-PES sulfonated support 200 initial flux. The flux of the ps-GO/S-PES filtration apparatus 1000 also decreased rapidly during the first 8 hours of operation until reaching a relatively steady flux of about 3.0 GFD. However, the flux decrease observed for the ps-GO/S-PES filtration apparatus 1000 is significantly smaller than that of the S-PES sulfonated support 200. After 20 hours of continuous operation, the ps-GO/S-PES filtration apparatus 1000 displayed a flux which is roughly 0.5 GFD larger than that of the S-PES sulfonated support 200. FIG. 5 also shows the S-PES sulfonated support 200 displayed an initial rejection rate of 62%, which fluctuated between approximately 57% and 62% during operation at 300 psi. The ps-GO/S-PES filtration apparatus 1000 displayed an initial rejection rate of 63%, which gradually grew to about 64% during the first 25 hours of operation at 300 psi.

Increasing the operating pressure from 300 psi to 500 psi resulted in higher fluxes for both the S-PES sulfonated support 200 and the ps-GO/S-PES filtration apparatus 1000. Interestingly, the difference between the flux of the ps-GO/S-PES filtration apparatus 1000 and the S-PES sulfonated support 200 increased from 0.5 GFD (at pressure of 300 psi) to about 1.0 GFD (at a pressure of 500 psi), evidencing the improved performance of the filtration apparatus which includes the ps-GO membrane. Further increasing the operating pressure from 500 psi to 800 psi resulted in a larger difference between the flux of the ps-GO/S-PES filtration apparatus 1000 and the S-PES sulfonated support 200, which grew from 1.0 GFD to about 1.5 GFD. Increasing the operating pressure from 300 psi to 500 psi and 800 psi causes the rejection rate of the ps-GO/S-PES filtration apparatus 1000 and the S-PES sulfonated support 200 to increase. More specifically, the rejection rate of the ps-GO/S-PES filtration apparatus 1000 increased to about 69% at 500 psi, and to about 75% at 800 psi, while that of the S-PES sulfonated support 200 increased to about 65% at 500 psi, and 69% at 800 psi.

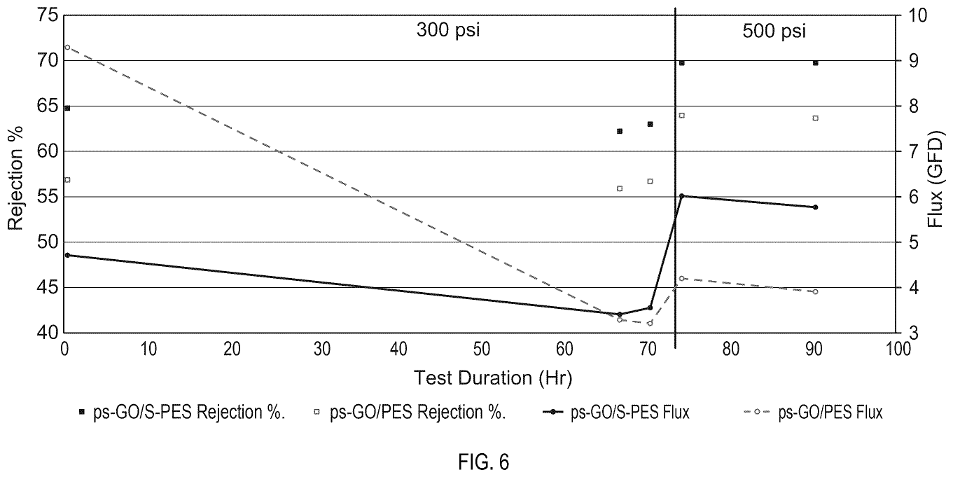

FIG. 6 shows the water flux (in gal/ft²/day, or GFD) and rejection rate (%) of a filtration apparatus 1000 including a ps-GO membrane disposed on an S-PES sulfonated support 200 (ps-GO/S-PES trace), and a ps-GO membrane disposed on a PES support (ps-GO/PES trace). The PES support described in FIG. 6 corresponds to a commercially available PES support (UP010P, Microdyn M+H). The S-PES sulfonated support 200 described in FIG. 6 included a thick backing layer, one or more intermediate layer(s) and/or interlayer(s), and one top layer, similar in structure to the S-PES sulfonated support 200 shown in FIG. 2B. The rejection rates shown in FIG. 6 were measured using a crossflow filtration cell, flowing a Weak Black Liquor solution (WBL) at a flowrate of 0.237 gal per minute, a temperature of 50° C., and a pressure of 300, and 500 psi. FIG. 6 illustrates the effect coupling a graphene oxide membrane that comprises a hydrophilic chemical spacer (e.g., propionamide, ps-GO) with (a) a support that displays improved hydrophilic character (e.g., the S-PES sulfonated support 200) and (b) a PES support. When operating at a pressure of 300 psi, the ps-GO/S-PES filtration apparatus 1000 displayed an initial flux of about 4.7 GFD, which slowly decreased 27.6% over 70 hours of continuous operation until reaching a flux of about 3.6 GFD. The ps-GO/PES system displayed an initial flux of nearly 9.3 GFD, which is significantly larger flux than that observed with the ps-GO/S-PES filtration apparatus 1000. However, the initial flux observed with the ps-GO/PES system decreased progressively 65.5% during 70 hours of operation at 300 psi until reaching a flux of about 3.2 GFD. It is worth noting that after 70 hours of operation, the ps-GO/S-PES filtration apparatus 1000 displayed a flux 0.2 GFD higher than the flux obtained with the ps-GO/PES system. The sharp decrease in the flux observed with the ps-GO/S-PES may be caused by poor and/or limited adhesion and compatibility between the ps-GO membrane and the PES support, which can introduce defects and delamination during continuous operation.

FIG. 6 also shows the ps-GO/S-PES filtration apparatus 1000 exhibited an initial rejection rate of 65%, which decreased slightly to about 62% after 70 hours of operation at 300 psi. The ps-GO/PES system displayed an initial rejection rate much lower than that observed with the ps-GO/S-PES filtration apparatus 1000 and reached a maximum rejection rate of only 57% during the 70 hours of operation at 300 psi. The differences in the performance of the ps-GO/S-PES filtration apparatus 1000 and the ps-GO/PES system shown in FIG. 6 highlight the superior long-term durability and stability exhibited by the filtration apparatus 1000 due to the sulfonated support 200 and the graphene oxide membrane comprising the propionamide chemical spacer.

Increasing the pressure from 300 psi to 500 psi resulted in higher fluxes for the ps-GO/S-PES filtration apparatus 1000 and the ps-GO/PES system. Interestingly, the flux of the GO/S-PES filtration apparatus 1000 increased to as high as about 6.0 GFD at 500 psi, which is a 1.8 GFD higher flux than that observed with the ps-GO/PES system at that pressure. The rejection rates displayed by the GO/S-PES filtration apparatus 1000 and the ps-GO/PES system also increased when increasing the pressure from 300 psi to 500 psi. The rejection rate of the GO/S-PES filtration apparatus 1000 reached a maximum of 70% at 500 psi while the rejection rate of the ps-GO/PES system reached a maximum of only 64%.

The rejection rates described herein were measured using WBL solutions which contain solute species at the high concentrations (e.g., monovalent and/or divalent salts at 1 wt. % or higher) routinely found in commercially relevant applications and/or processes (e.g., black liquor or seawater processing). It is worth noting that the majority of prior art graphene oxide membranes typically report performance measurements conducted and/or evaluated at low solute concentrations (e.g., salt concentration ≤ 0.5 wt. %), particularly in laboratory settings, which may result in very high rejection rates (e.g., >90%) due to material absorption rather than membrane permeance. Increasing the concentration of the solute species present in the solution leads to a sharp reduction of the measured rejection rate. For example, the rejection rate of graphene oxide membranes measured using an aqueous solution containing 0.584 wt. % NaCl (˜0.1 M) can be as high as 80%. Increasing the concentration of NaCl in the aqueous solution from 0.584 wt. % to 2.92 wt. % (˜ 0.5 M) can decrease the rejection rate to about 45%. The high rejection rates typically observed at low salt concentrations are attributed to electrostatic repulsion between negatively charged carboxylic acid groups present on the graphene oxide (e.g., at pH>4) and the salt anions in the solution. Repulsion is particularly enhanced for divalent anions. As the concentration of salt is increased, the charges on the membrane are shielded by the ions present in the salt solution, which cause the electrostatic repulsion to decrease. Under those conditions, the permeance of the filtration apparatus has a dominant effect on the observed rejection rate.

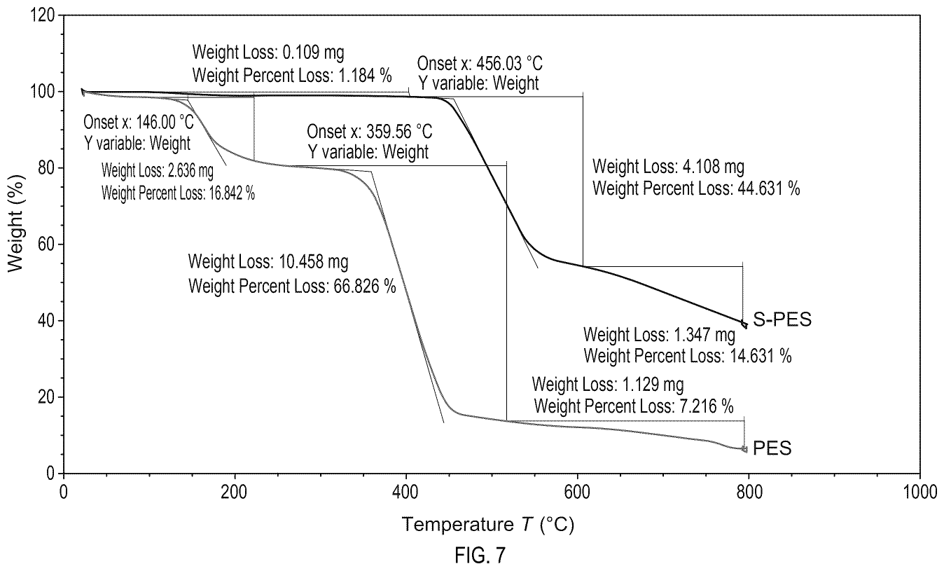

As described above, in some embodiments, the sulfate groups can also impart one or more chemical and/or physical properties and/or characteristics to the sulfonated support 200, such that the filtration apparatus 1000 exhibits improved durability and/or resistance to harsh environments. For example, in some embodiments the sulfate groups on the sulfonated support 200 can improve the thermal stability of the sulfonated support 200, enabling the use of the filtration apparatus 1000 at high temperatures for extended periods of time. FIG. 7 shows thermogravimetric analyzer (TGA) curves illustrating the thermal stability of a PES support sample (UP010P, Microdyn M+H) and an S-PES sulfonated support 200 sample similar in structure to the S-PES sulfonated support 200 shown in FIG. 2B. FIG. 7 shows the PES support sample displayed a first onset temperature of about 146° C., and a second onset degradation temperature of about 360° C. Additional TGA experiments (not shown) revealed the first onset temperature observed with the PES support is not related to moisture and/or water evaporation. During those experiments, PES samples were loaded on the TGA analyzer, held at 24 C for a period of time, heated to 100 C, and then kept at 100 C for 5 min to facilitate removal of potential water adsorbed within the PES sample. This procedure resulted in negligible weight losses at 100° C., suggesting that the weight loss observed at 146° C. with the PES samples is not associated with water loss.

The TGA curve of FIG. 7 further reveals that the PES support can undergo considerable thermal degradation and lose nearly 66.8% of its weight at the second onset degradation temperature. At a temperature of 800° C. or above, the PES support can show a residual weight of only about 3%. Consequently, the PES support may not be best suited for applications that involve high temperatures and or exposure to high temperatures for extended periods of time. The TGA curves of FIG. 7 also show the S-PES sulfonated support 200 displayed an onset degradation temperature of about 456° C. with an associated weight loss of about 44.6%. Furthermore, at a temperature of 800° C. or above, the S-PES sulfonated support 200 can show a residual weight of about 38%, which is a much higher percentage than that observed with the PES support as described above. Without being bound by any particular theory, it is believed that the presence of sulfate groups incorporated to the backbone of the S-PES polymeric material can improve the temperature stability of the S-PES sulfonated support 200, resulting in negligible weight loss at temperatures below 400° C. Consequently, an S-PES sulfonated support 200 can improve the thermal stability of the filtration apparatus 1000 and enable the use of the graphene oxide membrane 100 at high temperatures.

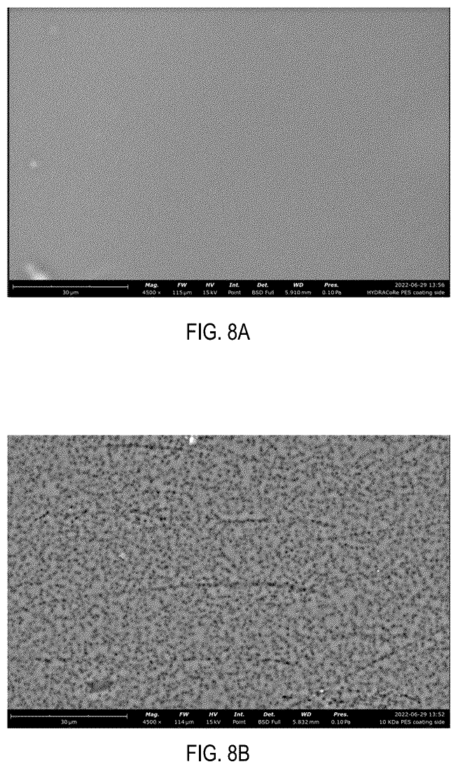

FIGS. 8A and 8B show Scanning Electron Microscope (SEM) micrographs revealing the microstructure, porosity, and pore size distribution of a PES support (UP01OP, Microdyn M+H) and a S-PES sulfonated support 200 (including a thick a backing layer, one or more interlayer(s), and a top layer similar in structure to the S-PES sulfonated support 200 shown in FIG. 2B), respectively. FIG. 8A shows the top layer of the S-PES sulfonated support 200 has a fine monodispersed porous structure characterized by an average pore size of about 0.008 μm, as determined by analysis of the SEM image via Image J software. Similarly, FIG. 8B shows the PES support also has a fine monodispersed porous structure with an average pore size of about 0.038 μm.

It is important to note that despite the fact that the S-PES sulfonated support 200 has a much smaller average pore size than the PES support, the former displayed a higher flux and rejection rate during the performance test in WBL solution described above with reference to FIGS. 5 and 6. Without being bound by any particular theory, it is believed that this increased performance observed with the S-PES sulfonated support 200 can be associated to a higher chemical affinity between the S-PES sulfonated support 200 and the GO membrane, particularly, when the GO membrane includes chemical spacers having a hydrophilic character.

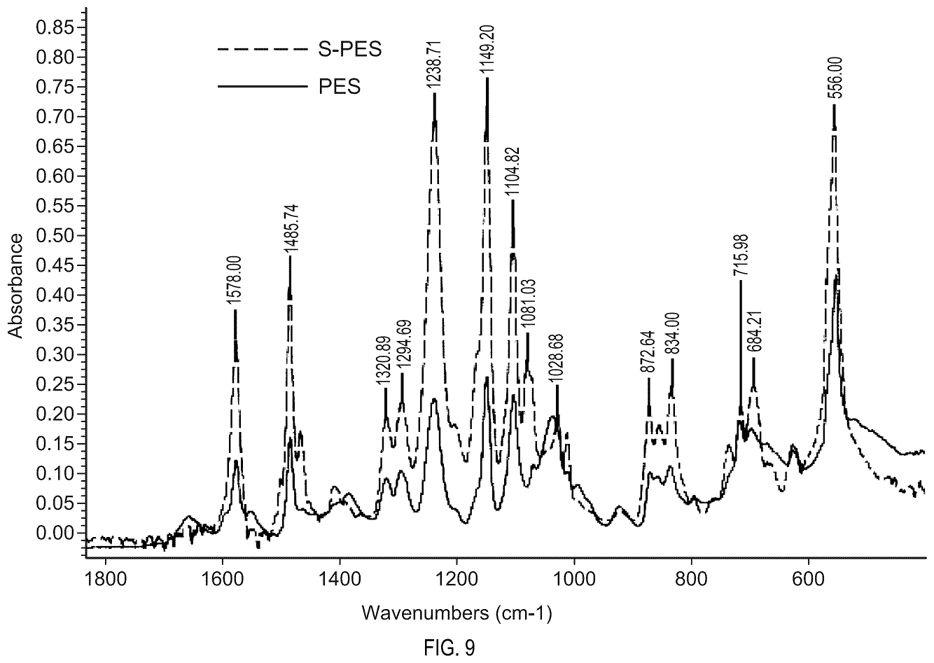

FIG. 9 shows Fourier Transformed Infrared (FT-IR spectra) of a PES support (UP010P, Microdyn M+H) and an S-PES sulfonated support 200 similar in structure to the S-PES sulfonated support shown in FIG. 2B recorded at room temperature. The spectra was recorded by exposing a surface of the PES support and the top layer 203 of the S-PES sulfonated support 200 to infrared radiation using an Attenuated Total Reflectance accessory (ATR). The spectrum of the S-PES sulfonated support 200 reveals the presence of a band at 1028 cm⁻¹ attributed to the aromatic SO₃H symmetric stretching vibration of the pendant sulfate groups. This band confirms the presence of the sulfate groups chemically bonded to alternating benzene rings in the S-PES sulfonated support 200.

### Manufacture of the Filtration Apparatus

The fabrication of the filtration apparatus 1000 involves preparing a graphene oxide solution and/or dispersion and depositing the solution and/or dispersion on the sulfonated support 200. In some embodiments, the fabrication of the graphene oxide membrane 100 includes dispersing graphene oxide sheets in a solvent to produce a stable dispersion. In some embodiments, the solvent can be water. In some embodiments, the solvent can be an organic solvent. The dispersion may exhibit certain physical and chemical characteristics in order to produce continuous and uniform coatings substantially free of structural defects such as pinholes. For example, the hydrophilicity of the dispersion should be adequately matched to that of the sulfonated support 200 to ensure wetting of the sulfonated support 200 surface. This can be tested by contact angle measurements.

The stability of the dispersion can be inferred from the pH of the dispersion. For example, dispersions that exhibit acidic pH values (e.g., pH<5) can develop visible aggregates. Fabricating coatings with such dispersions can lead to poor coverage, coating non-uniformity, and poor membrane performance. In contrast, dispersions that have basic pH are stable. Moreover, addition of basic additives to the dispersion can increase the magnitude of the zeta potential on the graphene oxide sheets, which in turn results in greater Coulombic stabilization.

The stability of the dispersion can be indirectly observed through UV-Vis spectroscopy measurements, owing to the absorption band at around 300 nm, attributed to n-to-p* transitions. At longer wavelengths (>500 nm) the graphene oxide sheets absorb very weakly, and consequently, any signal in this region can be attributed to scattering, rather than absorption, due to the formation of aggregates. The ratio of UV-Vis signal at 300 nm (due to absorption) and that observed at 600nm (due to aggregate scattering) can be used to characterize the dispersion in the solution. Generally, the higher this ratio is, the better the graphene oxide sheets 110 are dispersed.

In some embodiments, the ratio of UV-Vis signal at 300 nm and that observed at 600 nm can be less than about 4.4, less than about 4.2, less than about 4.0, less than about 3.8, less than about 3.6, less than about 3.4, less than about 3.2, or less than about 3.0, inclusive of all values and ranges therebetween. In some embodiments, the ratio of UV-Vis signal at 300 nm and that observed at 600 nm can be at least about 3.0, at least about 3.1, at least about 3.2, at least about 3.3, or at least about 3.4, inclusive of all values and ranges therebetween.

Combinations of the above referenced ranges for the ratio are also possible (e.g., a ratio of at least about 3.0 to less than about 4.4, at least about 3.2 to less than about 4.0).

In some embodiments, the dispersion can further include viscosity modifiers and/or surfactants. In some embodiments, the viscosity modifier is hydroxypropyl methyl cellulose (HPMC). For example, the dispersion can include 0.01 wt % viscosity modifier. In some embodiments, the surfactant is sodium dodecyl sulfide (SDS). For example, the dispersion can include about 0.15 wt % surfactant.

In some embodiments, the viscosity of the dispersion can be no more than about 1000 cP at a shear rate of around 0.08 Hz, no more than about 1500 cP at a shear rate of around 0.08 Hz, no more than about 2000 cP at a shear rate of around 0.08 Hz, no more than about 2500 cP at a shear rate of around 0.08 Hz, no more than about 3000 cP at a shear rate of around 0.08 Hz, no more than about 3000 cP at a shear rate of around 0.08 Hz, no more than about 3500 cP at a shear rate of around 0.08 Hz, no more than about 4000 cP at a shear rate of around 0.08 Hz, no more than about 5000 cP at a shear rate of around 0.08 Hz, no more than about 6000 cP at a shear rate of around 0.08 Hz, or no more than about 8000 cP at a shear rate of around 0.08 Hz.

Combinations of the above referenced ranges for the viscosity of the dispersion are also possible (e.g., a viscosity of at least about 10 cP and to no more than about 1000 cP at a shear rate of around 0.08 Hz, at least about 200 cP to no more than about 1500 cP at a shear rate of around 0.08 Hz).

To produce dispersions that can coat well onto the sulfonated support 200, the order of addition of reagents can be important. For example, prior to deposition, dispersions that undergo carbodiimide coupling conditions require adjustment of the pH to be greater than 8.0 prior to the addition of 1-Ethyl-3-(3-dimethylaminopropyl) carbodiimide (EDC) and N-hydroxysuccinimide (NHS).

Prior to the reaction with a chemical spacer precursor, the graphene oxide sheets 110 can be functionalized with one or more desirable chemical groups. For example, the graphene oxide sheets can be functionalized with amines. See Navaee, A. & Salimi, A, “Efficient amine functionalization of graphene oxide through the Bucherer reaction: an extraordinary metal-free electrocatalyst for the oxygen reduction reaction,” RSC Adv. 5, 59874-59880 (2015), the contents of which are incorporated by reference.

The graphene oxide sheets can also be functionalized with carboxylic groups, as described above with respect to the incorporated references Sydlik, S. A. & Swager, T. M., “Functional Graphenic Materials Via a Johnson-Claisen Rearrangement,” Adv. Funct. Mater. 23, 1873-1882 (2012); and Collins, W. R., et al., “Rearrangement of Graphite Oxide: A Route to Covalently Functionalized Graphenes,” Angew. Chem., Int. Ed. 50, 8848-8852 (2011).

In some embodiments, the graphene oxide sheets can be functionalized with hydroxyl groups. For example, a graphene oxide sheet can react with an epoxide so that the graphene oxide sheet is functionalized with hydroxyl groups. Examples of epoxides include, but are not limited to, 1-2-epoxypropane, styrene oxide, ethylene oxide, epichlorohydrine, 1,2-epoxybutane, bisphenol, A diglycidyl ether, 1, 3-butadiene diepoxide and 1,2,7,8-diepoxyoctane.

Once the graphene oxide sheets have the desired chemical groups, they can be placed in contact with the chemical spacer precursor to initiate a reaction between the graphene oxide sheets and the chemical spacer precursor. The reaction conditions can vary, depending on the chemical spacer 120 used. As compared to existing processes, some embodiments of the process of the present disclosure can be performed under ambient environments (i.e., in the presence of oxygen and humidity).

In some embodiments, the graphene oxide sheets can be optionally coupled to an adjacent graphene oxide sheet via a chemical linker. In some embodiments molecules useful for initiating crosslinking between graphene oxide sheets can include, but are not restricted to, ester groups, sulfonated esters, ether groups, amines, carboxyl groups, carboxylic acids, carbonyl groups, amides, halides, thiols, alkanes, fluoroalkanes, alkyl groups, methyl groups, ethyl groups, propyl groups, butyl groups, pentyl groups, heptyl groups, octyl groups, nonyl groups, decyl groups, isopropyl, cyclopropyl, isobutyl, t-butyl, cyclobutyl, cyclohexyl, chloromethyl, bromoethyl, trifluoromethyl, methylamine, dimethylamine, ethylamine, diethylamine, methylethylamine, iso-propylamine, piperidine, trimethylamine, propylamine, hydroxy groups, hydroxyl groups, thio groups, 1,3,5-benzenetricarbonyl trichloride, aromatic dichlorides, aromatic trichlorides, terephthaloyl chloride, adipoyl chloride, propanediol, pentanediol, hexanediol, heptanediol, naphthyl, biphenyl, benzyl, hexyldiamine, 1,6-diiodohexane, 1,6-dibromohexane, 1,6-dichlorohexane, a,α′-dichloro-p-xylene, a,α′-diiodo-p-xylene, a,α′-dibromo-p-xylene, dichloromethylnapthalene, trichloromethylbenzene, dichloromethylbiphenyl, dibromomethylnapthalene, tribromomethylbenzene, dibromomethylbiphenyl, diiodomethylnapthalene, triiodomethylbenzene, diiodomethylbiphenyl, any other suitable crosslinking moieties, or combinations thereof.

In some embodiments, crosslinking moieties can be coupled to at least one graphene oxide sheet through esterification under appropriate reaction conditions.

In some embodiments, crosslinking moieties can be coupled to at least one graphene oxide sheet through esterification under appropriate reaction conditions.

As described above, the fabrication of the filtration apparatus 1000 requires depositing a graphene oxide solution and/or dispersion on the sulfonated support 200. In some embodiments, the graphene oxide dispersion can be deposited on the sulfonated support 200 using one or more coating techniques. For example, in some embodiments the graphene oxide dispersion can be deposited using coating techniques such as solvent casting, spin coating, cold spray coating, dip casting, drop casting, and/or tape casting. In some embodiments, a graphene oxide dispersion can be coated on to one side of a sulfonated support 200 using a casting rod. The casted graphene oxide dispersion can then be allowed to dry at room temperature and/or at any suitable temperature (e.g., in an oven) to produce the graphene oxide membrane 100. Additionally and/or optionally, in some embodiments, the graphene oxide membrane 100 can be further washed with a suitable solvent. For example, in some embodiments, the graphene oxide membrane 100 can be washed with one or more solvents including, but not limited to ethanol, propanol, and/or any suitable aliphatic alcohol (e.g., R—OH), dichloromethane, acetonitrile, dimethyl sulfoxide, acetone, dimethylformamide (DMF), dioxane, butanone, carbon tetrachloride.

### Applications

The filtration apparatus 1000 disclosed herein can be used for a wide range of nanofiltration or microfiltration applications, including but not limited to, concentration of molecules (e.g., whey, lactose), kraft pulping (e.g., wood pulp), sulfite pulping, demineralization or desalting (e.g., lactose, dye, chemicals, pharmaceuticals), fractionation (e.g., sugars), extraction (e.g., nutraceuticals, plant oils), recovery (e.g., catalyst, solvent), and purification (e.g., pharmaceutical, chemical, fuel), as well as applications in which high chemical stability and high monovalent and divalent ion rejection are required, such as acid concentration, sucrose concentration, and/or homogeneous catalyst concentration and/or purification. For example, a fluid comprising a plurality of species (e.g., plurality of retentate species) may be placed in contact with a first side of the graphene oxide membrane 100. The graphene oxide membrane 100 may have interlayer spacing and/or intralayer spacing that are sized to prevent at least a portion of the species from traversing the membrane through the interlayer spacing and/or intralayer spacing, i.e., flowing from the first side of the graphene oxide membrane and to a second, opposing side of the graphene oxide membrane 100. In some embodiments, the fluid may include one or more types of species (e.g., a retentate species or a permeate species). In some embodiments, the graphene oxide membrane 100 may have an average interlayer spacing and/or intralayer spacing that is sized to prevent at least a portion of the retentate species from traversing the graphene oxide membrane, while allowing at least a portion (e.g., substantially all) of the permeate species to traverse the graphene oxide membrane.

The filtration apparatus 1000 disclosed herein can also be used for the concentration of black liquor. Black liquor is a byproduct of the kraft pulping process, generated during conversion of wood into cellulose fibers for pulp and paper products. Black liquor produced in pulp mills can contain sodium sulfate, sodium carbonate, sodium hydrosulfide, sodium thiosulfate, and/or sodium hydroxide, residual fibers from the pulping process, as well as larger size (e.g., high molecular weight) organic species including hemicellulose, cellulose, and lignin, among others. In some instances, black liquor streams from pulp digestion can have a total concentration of dissolved and suspended solids in the range of approximately 10 to 20 wt. %. These streams, which can also be referred to as Weak black liquor (WBL), are generally produced at 80° C. to 90° C. Cooling the WBL prior to filtration would be very expensive and energy intensive. Without the need for cooling, the WBL can pass through the graphene oxide membrane described herein at a high temperature, e.g., 80° C. to 90° C., 75° C. to 85° C., 70 to 80° C., or 65 to 75° C. In some embodiments, WBL can be flowed through the filtration apparatus 1000 described herein, wherein the WBL comprises lignin, sodium sulfate, sodium carbonate, sodium hydrosulfide, sodium thiosulfate, sodium hydroxide, as well as larger size organic species including hemicellulose, and cellulose. In some embodiments, the filtration apparatus 1000 can be designed to receive and operate on a WBL solution having a total concentration of dissolved and suspended solids of at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, or at least at least 20 wt. %, inclusive of all values and ranges therebetween. In some embodiments, the filtration apparatus 1000 can be designed to receive and operate on a WBL solution having a total concentration of dissolved and suspended solids of no more than about 20 wt. %, no more than about 18 wt. %, no more than about 16 wt. %, no more than about 14 wt. %, no more than about 12 wt. %, or no more than about 10 wt. %, inclusive of all values and ranges therebetween. The filtration apparatus 1000 can operate in flowing the WBL solution to produce a permeate stream and a concentrated stream. The permeate stream contains all the species included in the WBL solution which can diffuse through the components of the filtration apparatus 1000 (e.g., diffuse through the sulfonated support 200 and the graphene oxide membrane 100). The concentrate stream contains all the remaining species in the WBL solution which are prevented from diffusing (e.g., rejected) by the components of the filtration apparatus 1000. In some embodiments, the filtration apparatus 1000 can be flown a WBL solution and produce a permeate stream having a total concentration of dissolved and suspended solids of no more than about 9.0 wt. %, no more than about 8.0 wt. %, no more than about 7.5 wt. %, no more than about 7.0 wt. %, no more than about 6.5 wt. %, no more than about 6.0 wt. %, no more than about 5.5 wt. %, no more than about 5.0 wt. %, no more than about 4.5 wt. %, no more than about 4.0 wt. %, no more than about 3.5 wt. %, no more than about 3.0 wt. %, or no more than about 2.5 wt. %, inclusive of all values and ranges therebetween.

Combinations of the above referenced ranges for the total concentration of solids in the permeate 103 are also possible (e.g., at least about 3.0 wt. % to less than about 7.0 wt. %, or at least about 3.5 wt. % to less than about 6.0 wt. %)

In some embodiments, the filtration apparatus 1000 can have a flux greater than about 3.0 GFD, greater than about 4.0 GFD, greater than about 4.5 GFD, greater than about 5.0 GFD, greater than about 5.5 GFD, greater than about 6.0 GFD, greater than about 6.5 GFD, greater than about 7.0 GFD, greater than about 7.5 GFD, greater than about 8.0 GFD, greater than about 8.5 GFD, greater than about 9.0 GFD, greater than about 9.5 GFD, greater than about 10 GFD, greater than about 12 GFD, greater than about 14 GFD, greater than about 16 GFD, greater than about 18 GFD, greater than about 20 GFD, greater than about 25 GFD, greater than about 30 GFD, greater than about 40 GFD, or greater than about 50 GFD, measured with a weak black liquor solution containing between about 2 and 20 wt. % total concentration of dissolved and suspended solids including, for example, sodium sulfate, sodium carbonate, sodium hydrosulfide, sodium thiosulfate, sodium hydroxide, tall oils, carbohydrates, lignin, cellulose, hemicellulose, or a combination thereof, at a cross flow velocity of at least 0.1 m/sec, a predetermined pressured, and a temperature of at least 50° C.

In some embodiments, the filtration apparatus 1000 can have a flux of less than about 50 GFD, less than about 40 GFD, less than about 30 GFD, less than about 20 GFD, less than about 15 GFD, less than about 10 GFD, measured with weak black liquor at a cross flow velocity of at least 0.1 m/sec, a predetermined pressure, and a temperature of at least 70° C.

Combinations of the above-referenced ranges for the flux are also contemplated (e.g., greater than about 8.0 GFD and less than about 12 GFD, or greater than about 5 GFD and less than about 30 GFD).

In some some embodiments, the flux is measured at a predetermined pressure of 50 psi to 1000 psi, such as about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, about 650 psi, about 675 psi, about 700 psi, about 725 psi, about 750 psi, about 775 psi, about 800 psi, about 825 psi, about 850 psi, about 875 psi, about 900 psi, about 925 psi, about 950 psi, about 975 psi, or about 1000 psi.

The performance of the filtration apparatus 200 for WBL filtration can be assessed by the rejection rate on a total solids basis. In some embodiments, the rejection rate is between about 55% and about 85% on a total solids basis, e.g., between about 60% and about 70%, between about 65% and about 75%, or between 70% and about 85% on a total solids basis.

In some embodiments, the filtration apparatus 1000 and/or the sulfonated support 200 can reject at least a portion of the lignin. In some embodiments, the filtration apparatus 1000 and/or the sulfonated support 200 can reject at least about 50%, at least about 50%, at least about 55%, at least about 60%, at least about 65%, at least about 70%, at least about 75%, or at least about 85% of the lignin.

In some embodiments, the filtration apparatus 1000 and/or the sulfonated support 200 can reject at least a portion of the sodium sulfate. In some embodiments, the filtration apparatus 1000 and/or the sulfonated support 200 can reject at least about 50%, at least about 55%, at least about 60%, at least about 65%, at least about 70%, at least about 75%, or at least about 85% of the sodium sulfate.

In some embodiments, the filtration apparatus 1000 and/or the sulfonated support 200 can reject at least a portion of the sodium carbonate. In some embodiments, the filtration apparatus 1000 and/or the sulfonated support 200 can reject at least about 50%, at least about 55%, at least about 60%, at least about 65%, at least about 70%, at least about 75%, or at least about 85% of the sodium carbonate.

In some embodiments, the filtration apparatus 1000 and/or the sulfonated support 200 can reject at least a portion of the sodium hydrosulfide. In some embodiments, the filtration apparatus 1000 and/or the sulfonated support 200 can reject at least about 50%, at least about 55%, at least about 60%, at least about 65%, at least about 70%, at least about 75%, or at least about 85% of the sodium hydrosulfide.

In some embodiments, the filtration apparatus 1000 and/or the sulfonated support 200 can reject at least a portion of the sodium thiosulfate. In some embodiments, the filtration apparatus 1000 and/or the sulfonated support 200 can reject at least about 50%, at least about 55%, at least about 60%, at least about 65%, at least about 70%, at least about 70%, or at least about 85% of the sodium thiosulfate.

In some embodiments, the filtration apparatus 1000 and/or the sulfonated support 200 can reject at least a portion of the sodium hydroxide. In some embodiments, the filtration apparatus 1000 and/or the sulfonated support 200 can reject at least about 50%, at least about 55%, at least about 60%, at least about 65%, at least about 70%, at least about 75%, or at least about 75% of the sodium hydroxide.

The filtration apparatus 1000 disclosed herein can be used in reverse osmosis to remove ions, molecules, and larger particles from a fluid, e.g., drinking water.

In some embodiments, the filtration apparatus 1000 disclosed herein can be used in methods for filtering raw milk, cheese whey, whey protein concentrate, mixtures comprising lactose, and whey protein isolate. The methods can include flowing the raw milk through the graphene oxide membrane.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

### Definitions

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially,” “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein, the term “graphene oxide sheet” means a single atomic graphene oxide layer or a plurality of atomic graphene oxide layers. Each atomic graphene oxide layer may include out-of-plane chemical moieties attached to one or more carbon atoms on the layer. In some embodiments, the term “graphene oxide sheet” means 1 to about 20 atomic graphene oxide layers, e.g., 1 to about 18, 1 to about 16, 1 to about 14, 1 to about 12, 1 to about 10, 1 to about 8, 1 to about 6, 1 to about 4, or 1 to about 3 atomic graphene oxide layers. In some embodiments, the term “graphene oxide sheet” means 1, 2, or 3 atomic graphene oxide layers. As used herein, the term “basic” means pH greater than 7.

As used herein, “wt %” refers to weight percent.

As used herein, the term “flux” means flow rate. It describes the permeability of a membrane.

As used herein, the term “optionally substituted” is understood to mean that a given chemical moiety (e.g., an alkyl group) can (but is not required to) be bonded other substituents (e.g., heteroatoms). For instance, an alkyl group that is optionally substituted can be a fully saturated alkyl chain (i.e., a pure hydrocarbon). Alternatively, the same optionally substituted alkyl group can have substituents different from hydrogen. For instance, it can, at any point along the chain be bounded to a halogen atom, a hydroxyl group, or any other substituent described herein. Thus the term “optionally substituted” means that a given chemical moiety has the potential to contain other functional groups, but does not necessarily have any further functional groups. Suitable substituents used in the optional substitution of the described groups include, without limitation, halogen, oxo, —OH, —CN, —COOH, —CH2CN, —O—(C1-C6) alkyl, (C1-C6) alkyl, C1-C6 alkoxy, (C1-C6) haloalkyl, C1-C6 haloalkoxy, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, —NH2, —NH((C1-C6) alkyl), —N((C1-C6) alkyl)2, —NHC(O)(C1-C6) alkyl, —C(O)NH(C1-C6) alkyl,—S(O)2(C1-C6) alkyl, —S(O)NH(C1-C6) alkyl, and —S(O)N((C1-C6)alkyl)2. The substituents can themselves be optionally substituted.

As used herein, the term “hydroxy” or “hydroxyl” refers to the group —OH or —O—. As used herein, “halo” or “halogen” refers to fluoro, chloro, bromo, and iodo.

The term “carbonyl” includes compounds and moieties which contain a carbon connected with a double bond to an oxygen atom. Examples of moieties containing a carbonyl include, but are not limited to, aldehydes, ketones, carboxylic acids, amides, esters, anhydrides, etc.

The term “carboxyl” refers to —COOH or its C1-C6 alkyl ester.

“Acyl” includes moieties that contain the acyl radical (R—C(O)—) or a carbonyl group. “Substituted acyl” includes acyl groups where one or more of the hydrogen atoms are replaced by, for example, alkyl groups, alkynyl groups, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

The term “alkoxy” or “alkoxyl” includes substituted and unsubstituted alkyl, alkenyl and alkynyl groups covalently linked to an oxygen atom. Examples of alkoxy groups or alkoxyl radicals include, but are not limited to, methoxy, ethoxy, isopropyloxy, propoxy, butoxy and pentoxy groups. Examples of substituted alkoxy groups include halogenated alkoxy groups. The alkoxy groups can be substituted with groups such as alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moieties. Examples of halogen substituted alkoxy groups include, but are not limited to, fluoromethoxy, difluoromethoxy, trifluoromethoxy, chloromethoxy, dichloromethoxy and trichloromethoxy.

The term “ester” includes compounds or moieties which contain a carbon or a heteroatom bound to an oxygen atom which is bonded to the carbon of a carbonyl group. The term “ester” includes alkoxycarboxy groups such as methoxycarbonyl, ethoxycarbonyl, propoxycarbonyl, butoxycarbonyl, pentoxycarbonyl, etc.

As used herein, “amino” or “amine,” as used herein, refers to a primary (—NH2), secondary (—NHRx), tertiary (—NRxRy), or quaternary amine (—N+RxRyRz), where Rx, Ry, and Rz are independently an aliphatic, alicyclic, heteroaliphatic, heterocyclic, aryl, or heteroaryl moiety, as defined herein. Examples of amine groups include, but are not limited to, methylamine, dimethylamine, ethylamine, diethylamine, methylethylamine, iso-propylamine, piperidine, trimethylamine, and propylamine. “Alkylamino” includes groups of compounds wherein the nitrogen of —NH2 is bound to at least one alkyl group. Examples of alkylamino groups include benzylamino, methylamino, ethylamino, phenethylamino, etc. “Dialkylamino” includes groups wherein the nitrogen of —NH2 is bound to two alkyl groups. Examples of dialkylamino groups include, but are not limited to, dimethylamino and diethylamino. “Arylamino” and “diarylamino” include groups wherein the nitrogen is bound to at least one or two aryl groups, respectively. “Aminoaryl” and “aminoaryloxy” refer to aryl and aryloxy substituted with amino. “Alkylarylamino,” “alkylaminoaryl” or “arylaminoalkyl” refers to an amino group which is bound to at least one alkyl group and at least one aryl group. “Alkaminoalkyl” refers to an alkyl, alkenyl, or alkynyl group bound to a nitrogen atom which is also bound to an alkyl group. “Acylamino” includes groups wherein nitrogen is bound to an acyl group. Examples of acylamino include, but are not limited to, alkylcarbonylamino, arylcarbonylamino, carbamoyl and ureido groups.

The term “amide” or “aminocarboxy” includes compounds or moieties that contain a nitrogen atom that is bound to the carbon of a carbonyl or a thiocarbonyl group. The term includes “alkaminocarboxy” groups that include alkyl, alkenyl or alkynyl groups bound to an amino group which is bound to the carbon of a carbonyl or thiocarbonyl group. It also includes “arylaminocarboxy” groups that include aryl or heteroaryl moieties bound to an amino group that is bound to the carbon of a carbonyl or thiocarbonyl group. The terms “alkylaminocarboxy”, “alkenylaminocarboxy”, “alkynylaminocarboxy” and “arylaminocarboxy” include moieties wherein alkyl, alkenyl, alkynyl and aryl moieties, respectively, are bound to a nitrogen atom which is in turn bound to the carbon of a carbonyl group. Amides can be substituted with substituents such as straight chain alkyl, branched alkyl, cycloalkyl, aryl, heteroaryl or heterocycle. Substituents on amide groups may be further substituted.

Unless otherwise specifically defined, the term “aryl” refers to cyclic, aromatic hydrocarbon groups that have 1 to 3 aromatic rings, including monocyclic or bicyclic groups such as phenyl, biphenyl or naphthyl. Where containing two aromatic rings (bicyclic, etc.), the aromatic rings of the aryl group may be joined at a single point (e.g., biphenyl), or fused (e.g., naphthyl). The aryl group may be optionally substituted by one or more substituents, e.g., 1 to 5 substituents, at any point of attachment. Exemplary substituents include, but are not limited to, —H, —halogen, —O—(C1-C6) alkyl, (C1-C6) alkyl, —O—(C2-C6) alkenyl, —O—(C2-C6) alkynyl, (C2-C6) alkenyl, (C2-C6) alkynyl, —OH, —OP(O)(OH)2, —OC(O)(C1-C6) alkyl, —C(O)(C1-C6) alkyl, —OC(O)O(C1-C6) alkyl, NH2, NH((C1-C6) alkyl), N((C1-C6) alkyl)2, —S(O)2—(C1-C6) alkyl, —S(O)NH(C1-C6) alkyl, and —S(O)N((C1-C6) alkyl)2. The substituents can themselves be optionally substituted. Furthermore, when containing two fused rings the aryl groups herein defined may have an unsaturated or partially saturated ring fused with a fully saturated ring. Exemplary ring systems of these aryl groups include, but are not limited to, phenyl, biphenyl, naphthyl, anthracenyl, phenalenyl, phenanthrenyl, indanyl, indenyl, tetrahydronaphthalenyl, tetrahydrobenzoannulenyl, and the like.

Unless otherwise specifically defined, “heteroaryl” means a monocyclic aromatic radical of 5 to 24 ring atoms or a polycyclic aromatic radical, containing one or more ring heteroatoms selected from N, O, or S, the remaining ring atoms being C. Heteroaryl as herein defined also means a bicyclic heteroaromatic group wherein the heteroatom is selected from N, O, or S. The aromatic radical is optionally substituted independently with one or more substituents described herein. Examples include, but are not limited to, furyl, thienyl, pyrrolyl, pyridyl, pyrazolyl, pyrimidinyl, imidazolyl, isoxazolyl, oxazolyl, oxadiazolyl, pyrazinyl, indolyl, thiophen-2-yl, quinolyl, benzopyranyl, isothiazolyl, thiazolyl, thiadiazole, indazole, benzimidazolyl, thieno[3,2-b]thiophene, triazolyl, triazinyl, imidazo[1,2-b]pyrazolyl, furo[2,3-c]pyridinyl, imidazo[1,2-a]pyridinyl, indazolyl, pyrrolo[2,3-c]pyridinyl, pyrrolo[3,2-c]pyridinyl, pyrazolo[3,4-c]pyridinyl, thieno[3,2-c]pyridinyl, thieno[2,3-c]pyridinyl, thieno[2,3-b]pyridinyl, benzothiazolyl, indolyl, indolinyl, indolinonyl, dihydrobenzothiophenyl, dihydrobenzofuranyl, benzofuran, chromanyl, thiochromanyl, tetrahydroquinolinyl, dihydrobenzothiazine, dihydrobenzoxanyl, quinolinyl, isoquinolinyl, 1,6-naphthyridinyl, benzo[de]isoquinolinyl, pyrido[4,3-b][1,6]naphthyridinyl, thieno[2,3-b]pyrazinyl, quinazolinyl, tetrazolo[1,5-a]pyridinyl, [1,2,4]triazolo[4,3-a]pyridinyl, isoindolyl, pyrrolo[2,3-b]pyridinyl, pyrrolo[3,4-b]pyridinyl, pyrrolo[3,2-b]pyridinyl, imidazo[5,4-b]pyridinyl, pyrrolo[1,2-a]pyrimidinyl, tetrahydro pyrrolo[1,2-a]pyrimidinyl, 3,4-dihydro-2H-1?2-pyrrolo[2,1-b]pyrimidine, dibenzo[b,d]thiophene, pyridin-2-one, furo[3,2-c]pyridinyl, furo[2,3-c]pyridinyl, 1H-pyrido[3,4-b][1,4]thiazinyl, benzooxazolyl, benzoisoxazolyl, furo[2,3-b]pyridinyl, benzothiophenyl, 1,5-naphthyridinyl, furo[3,2-b]pyridine, [1,2,4]triazolo[1,5-a]pyridinyl, benzo[1,2,3]triazolyl, imidazo[1,2-a]pyrimidinyl, [1,2,4]triazolo[4,3-b]pyridazinyl, benzo[c][1,2,5]thiadiazolyl, benzo[c][1,2,5]oxadiazole, 1,3-dihydro-2H-benzo[d]imidazol-2-one, 3,4-dihydro-2H-pyrazolo[1,5-b][1,2]oxazinyl, 4,5,6,7-tetrahydropyrazolo[1,5-a]pyridinyl, thiazolo[5,4-d]thiazolyl, imidazo[2,1-b][1,3,4]thiadiazolyl, thieno[2,3-b]pyrrolyl, 3H-indolyl, and derivatives thereof. Furthermore, when containing two fused rings the aryl groups herein defined may have an unsaturated or partially saturated ring fused with a fully saturated ring. Exemplary ring systems of these heteroaryl groups include indolinyl, indolinonyl, dihydrobenzothiophenyl, dihydrobenzofuran, chromanyl, thiochromanyl, tetrahydroquinolinyl, dihydrobenzothiazine, 3,4-dihydro-1H-isoquinolinyl, 2,3-dihydrobenzofuran, indolinyl, indolyl, and dihydrobenzoxanyl.

Furthermore, the terms “aryl” and “heteroaryl” include multicyclic aryl and heteroaryl groups, e.g., tricyclic, bicyclic, e.g., naphthalene, benzoxazole, benzodioxazole, benzothiazole, benzoimidazole, benzothiophene, quinoline, isoquinoline, naphthrydine, indole, benzofuran, purine, benzofuran, deazapurine, indolizine.

“Alkyl” refers to a straight or branched chain saturated hydrocarbon. C1-C6 alkyl groups contain 1 to 6 carbon atoms. Examples of a C1-C6 alkyl group include, but are not limited to, methyl, ethyl, propyl, butyl, pentyl, isopropyl, isobutyl, sec-butyl and tert-butyl, isopentyl and neopentyl.

An optionally substituted alkyl refers to unsubstituted alkyl or alkyl having designated substituents replacing one or more hydrogen atoms on one or more carbons of the hydrocarbon backbone. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl, alkylaryl, or an aromatic or heteroaromatic moiety.

As used herein, “alkenyl” includes unsaturated aliphatic groups analogous in length and possible substitution to the alkyls described above, but that contain at least one double bond. For example, the term “alkenyl” includes straight chain alkenyl groups (e.g., ethenyl, propenyl, butenyl, pentenyl, hexenyl, heptenyl, octenyl, nonenyl, decenyl), and branched alkenyl groups.

An optionally substituted alkenyl refers to unsubstituted alkenyl or alkenyl having designated substituents replacing one or more hydrogen atoms on one or more hydrocarbon backbone carbon atoms. Such substituents can include, for example, alkyl, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, amino (including alkylamino, dialkylamino, arylamino, diarylamino and acylamino alkylarylamino), (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, heterocyclyl, alkylaryl, or an aromatic or heteroaromatic moiety.

“Alkynyl” includes unsaturated aliphatic groups analogous in length and possible substitution to the alkyls described above, but which contain at least one triple bond. For example, “alkynyl” includes straight chain alkynyl groups (e.g., ethynyl, propynyl, butynyl, pentynyl, hexynyl, heptynyl, octynyl, nonynyl, decynyl), and branched alkynyl groups. In certain embodiments, a straight chain or branched alkynyl group has six or fewer carbon atoms in its backbone (e.g., C2-C6 for straight chain, C3-C6 for branched chain). The term “C2-C6” includes alkynyl groups containing two to six carbon atoms. The term “C3-C6” includes alkynyl groups containing three to six carbon atoms.

As used herein, the term “molecular weight cutoff” refers to at least 90% (e.g., at least 92%, at least 95%, or at least 98%) rejection rate for molecules with molecular weights greater than the cutoff value.

As used herein, the term “room temperature” can refer to a temperature of about 15° C., about 16° C., about 17° C., about 18° C., about 19° C., about 20° C., about 21° C., about 22° C., about 23° C., about 24° C., or about 25° C. In some embodiments, the room temperature is about 20° C.

As used herein, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

As used herein, the term “derivative” refers to a compound that is modified from a parent compound, such that the modified compound and the parent compound have a common core structure, while the parent compound is substituted with one or more substituents as described herein to arrive at the modified compound.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto

1. A filtration apparatus, comprising:
a sulfonated support; and
a graphene oxide membrane disposed on the sulfonated support, the graphene oxide membrane comprising a plurality of graphene oxide layers, each graphene oxide layer including at least one graphene oxide sheet covalently coupled to a chemical spacer,
wherein the filtration apparatus has a rejection rate of at least 60% in flowing a weak black liquor solution at a predetermined temperature pressure.

2. The filtration apparatus of claim 1, wherein the filtration apparatus has a flux of at least 3 gallons per square foot per day (GFD) in flowing the weak black liquor solution at a predetermined crossflow velocity.

3. The filtration of apparatus of claim 2, wherein the predetermined crossflow velocity is at least about 0.1 m/sec.

4. The filtration apparatus of claim 1, wherein the predetermined temperature is about 70° C.

5. The filtration apparatus of claim 1, wherein the predetermined pressure is at least about 300 psi.

6. The filtration apparatus of claims 1, wherein the sulfonated support includes at least one of a sulfonated polyethersulfone S-PES material, a sulfonated polypropylene, a sulfonated polystyrene, a sulfonated polyethylene, a sulfonated polysulfone, or a sulfonated tetrafluoroethylene.

7. The filtration apparatus of claim 6, wherein the sulfonated support includes:
a backing layer;
a top layer comprising the S-PES material; and
an interlayer disposed between the backing layer and the top layer.

8. The filtration apparatus of claim 6, wherein the sulfonated support includes:
a backing layer; and
a blended top layer disposed on the backing layer, the blended top layer including the S-PES material.

9. The filtration apparatus of claim 7, wherein the backing layer includes at least one of polypropylene, polystyrene, polyethylene, polyethersulfone, or polysulfone.

10. The filtration apparatus of claims 1, wherein the chemical spacer comprises an amide or a derivative thereof.

11. The filtration apparatus of claim 10, wherein the chemical spacer comprises —NH—C(O)—R2, and R2 is C₁-C₆ alkyl or C₂-C₆ alkenyl, each of which can be optionally substituted.

12. The filtration apparatus of claim 10, wherein the amide is acrylamide, propionamide, isobutyramide, or pivalamide.

13. The filtration apparatus of claim 1, wherein the chemical spacer comprises an amine or a derivative thereof.

14. The filtration apparatus of claim 13, wherein the chemical spacer comprises —NH—R1,and wherein R1 is an aryl, which can be optionally substituted.

15. The filtration apparatus of claim 13, wherein the amine is 4-aminophenylacetic acid or 2-(4-aminophenyl) ethanol.

16. The filtration apparatus of claims 1, wherein the predetermined pressure is at least about 300 psi and no more than 1200 psi.

17. The filtration apparatus of claims 1, wherein the temperature is about 70° C.

18. The filtration apparatus of claim 1, wherein each of the graphene oxide sheets is not covalently crosslinked to an adjacent graphene oxide sheet.

19. The filtration apparatus of claim 1, wherein each of the graphene oxide sheets is covalently crosslinked to an adjacent graphene oxide sheet.

20. The filtration apparatus of claim 19, further comprising a chemical linker covalently coupled to the chemical spacer to crosslink each of the graphene oxide sheets to the adjacent graphene oxide sheet.

21. The filtration apparatus of claim 20, wherein the chemical linker includes one of the following structures: 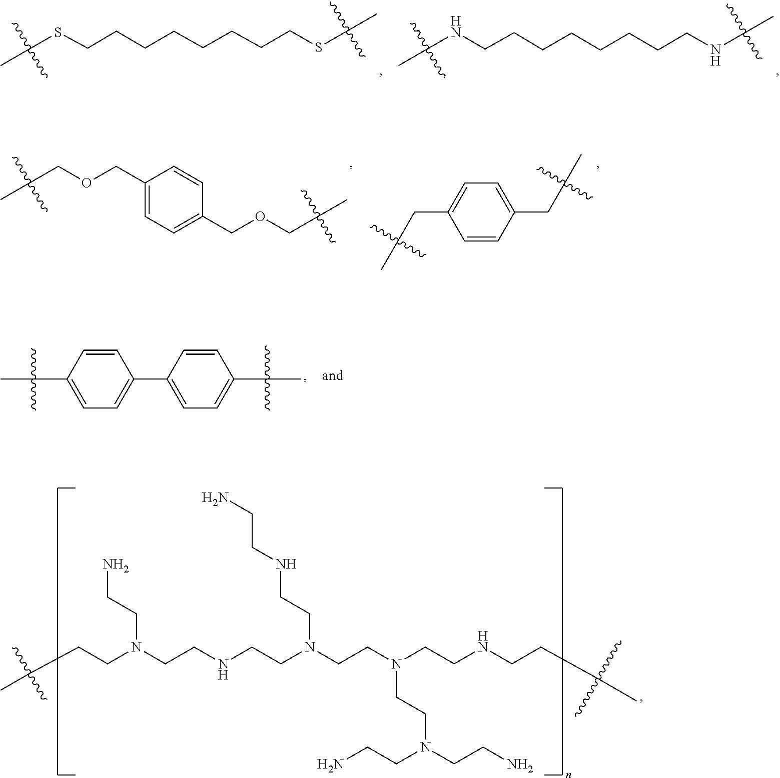
wherein:
n is 1 to 5; and [symbol]
denotes the point of coupling to the chemical spacer.

22. The filtration apparatus of claim 20, wherein the combination of the chemical linker and the chemical spacer has the following structure: 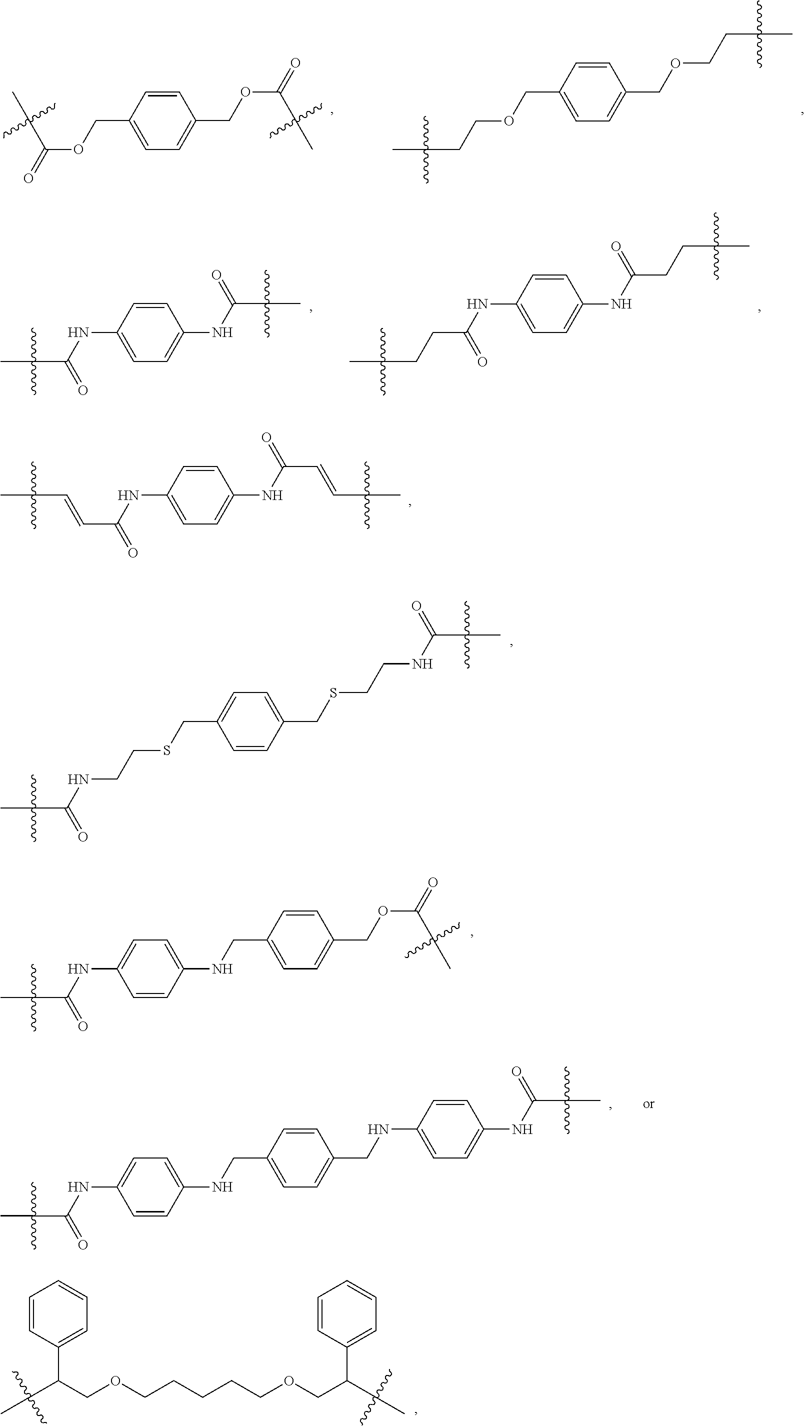
where [symbol] denotes the point of coupling with the graphene oxide sheet.

23. A filtration apparatus, comprising
a sulfonated support; and
a graphene oxide membrane disposed on the sulfonated support, the graphene oxide membrane comprising a plurality of graphene oxide layers, each graphene oxide layer including at least one graphene oxide sheet covalently coupled to a chemical spacer,
wherein the filtration apparatus is configured to flow a black liquor solution having an initial total concentration of no more than about 9 wt. % at a concentrate solids of 21%, and a predetermined temperature and pressure.

24. The filtration apparatus of 23, wherein filtration apparatus has a flux of at least 3 gallons per square foot per day (GFD) in flowing the weak black liquor solution at a crossflow velocity of at least 0.1 m/sec.

25. The filtration apparatus of claim 23, wherein the predetermined temperature is about 70° C.

26. The filtration apparatus of claim 23, wherein the predetermined pressure is at least about 300 psi.

27. The filtration apparatus of claims 23, wherein the sulfonated support includes a sulfonated polyether sulfone (S-PES) material.

28. The filtration apparatus of claim 27, wherein sulfonated support includes:
a backing layer;
a top layer comprising the S-PES material; and
an interlayer disposed between the backing layer and the top layer.

29. The filtration apparatus of claim 27, wherein the sulfonated support includes:
a backing layer; and
a blended top layer disposed on the backing layer, the blended top layer including the S-PES material.

30. The filtration apparatus of claim 28, wherein the backing layer includes at least one of polypropylene, polystyrene, polyethylene, polyethersulfone, or polysulfone.

31. The filtration apparatus of claims 23, wherein the chemical spacer comprises an amide or a derivative thereof.

32. The filtration apparatus of claim 31, wherein the chemical spacer comprises —NH—C(O)—R2, and R2 is C₁-C₆ alkyl or C₂-C₆ alkenyl, each of which can be optionally substituted.

33. The filtration apparatus of claim 31, wherein the amide is acrylamide, propionamide, isobutyramide, or pivalamide.

34. The filtration apparatus of claims 23, wherein the chemical spacer comprises an amine or a derivative thereof.

35. The filtration apparatus of claim 34, wherein the chemical spacer comprises —NH—R1, and R1 is an aryl, which can be optionally substituted.

36. The filtration apparatus of claim 34 wherein the amine is 4-aminophenylacetic acid or 2-(4-aminophenyl) ethanol.

37. The filtration apparatus of claim 23, wherein the predetermined pressure is at least about 300 psi and no more than 1200 psi.

38. The filtration apparatus of claim 37, wherein the temperature is about 70° C.

39. The filtration apparatus of claim 23, wherein each of the graphene oxide sheets is not covalently crosslinked to an adjacent graphene oxide sheet.

40. The filtration apparatus of claim 23, wherein each of the graphene oxide sheets is covalently crosslinked to an adjacent graphene oxide sheet.

41. The filtration apparatus of claim 40, further comprising a chemical linker covalently coupled to the chemical spacer to crosslink each of the graphene oxide sheets to the adjacent graphene oxide sheet.

42. The filtration apparatus of claim 41, wherein the chemical linker includes one of the following structures: 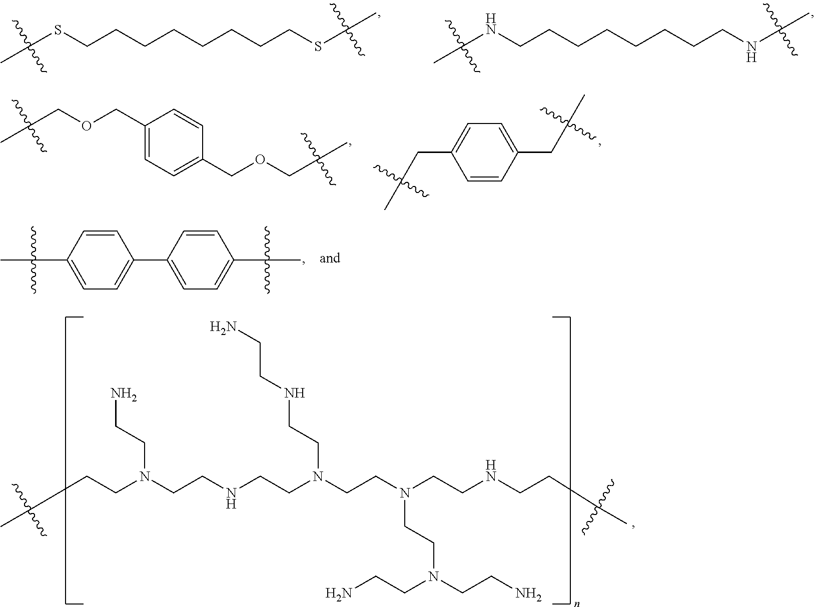
wherein:
n is 1 to 5; and [symbol]
denotes the point of coupling to the chemical spacer.

43. The filtration apparatus of claim 41, wherein the combination of the chemical linker and the chemical spacer has the following structure: 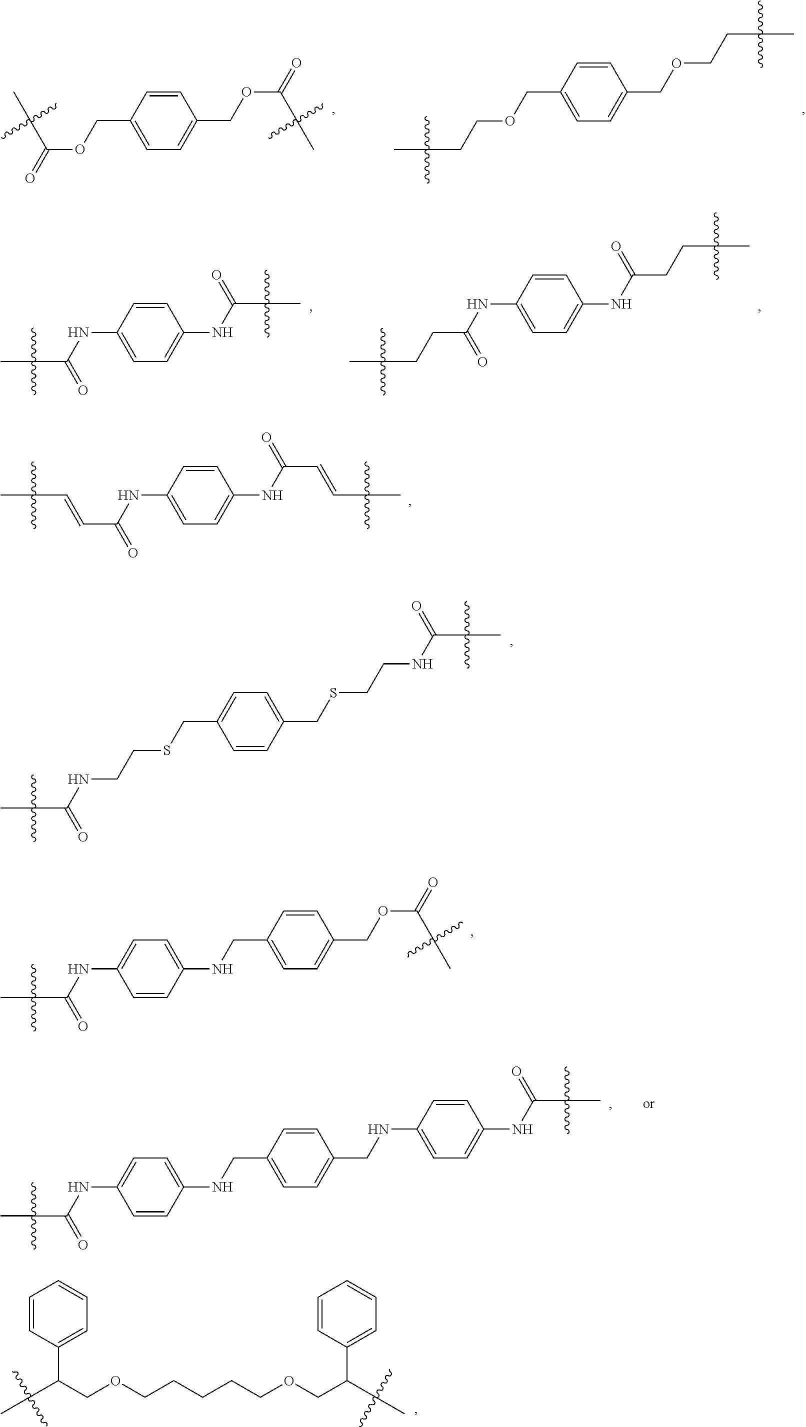
where [symbol] denotes the point of coupling with the graphene oxide sheet.
